(19) United States
(12) Patent Application Publication
(10) Pub. No.: US 2003/0069870 A1
(43) Pub. Date: Apr. 10, 2003

(54) Distributed decision processing system for multiple participants having different roles

(76) Inventors: Paul Coronelis Meindert Ras, Amsterdam (NL); Joep Josef Dirk Steffes, Alkmaar (NL)

Correspondence Address: WILSON SONSINI GOODRICH & ROSATI, 650 PAGE MILL ROAD, PALO ALTO, CA, 943041050

(21) Appl. No.: 09/895,854

(22) Filed: Jun. 29, 2001

(51) Int. Cl. G06N 5/00

(52) U.S. Cl. 706/54

(57) ABSTRACT

A method and system for collaborative decision making based on the identification of certain individuals involved. A computer system receives via a data network alternative choices, criteria by which the set of alternative choices may be evaluated, a set of weights indicating importance of criteria and evaluations corresponding to possible attributes of criteria. A relative analysis of the alternative choices is provided based on the set of evaluations, the set of weights and the identification of the individuals. Identifiers are used to distinguish assessors, and the assessments of assessors are treated differently depending on the identifier.

### REFERENCE TO RELATED APPLICATIONS

The present application is related to an application titled “Distributed Decision Processing System” by Jules Jacob Vos being filed concurrently herewith. The present application is also related to an application titled “Distributed Decision Processing System with Advanced Comparison-Engine” by Jacques van den Dool et al, being filed concurrently herewith.

### BACKGROUND OF THE INVENTION

1. Field of the Invention

This invention relates to the field of software and computer network systems. In particular, the invention relates to systems for computer aided assistance in decision making.

2. Description of the Related Art

Increasingly, individuals and organizations are faced with progressively more complex decisions based on numerous factors. Software systems have been developed to assist such individuals and organizations ih making decisions. In some such systems, a user enters information regarding alternative decisions and the system helps to compare alternatives and recommend an optimal choice.

An apparatus and method for assisting persons in making decisions using a computer is described in U.S. Pat. No. 5,182,793, invented by Alexander. Alexander describes making best choices for solving problems according to the application of rules. Alexander also describes permitting a user to select among various decision-making strategies and permitting the user to observe the effects of choices in hypothetical scenarios.

A system and process directed toward allowing collaboration within and between enterprises for optimal decision-making is described in U.S. Pat. No. 6,119,149, invented by Notani. Notani describes a computer-implemented process for enterprise collaboration. Notani indicates that a global decision support architecture can be built upon underlying link, vision, global messaging and data warehouse components.

Prior art software and systems to support decision-making are cumbersome and do not necessarily address the needs of users and organizations making complex decisions. Therefore, there is a need for improved software and systems to support decision-making.

### SUMMARY

An illustrative embodiment of the invention is a method for collaborative decision making based on the identification of certain individuals involved. A set of alternative choices is received in a computer system. The alternative choices are provided by a first set of individuals. A set of criteria by which the set of alternative choices may be evaluated are also received. The criteria are provided by a second set of individuals. A set of weights are sent to the computer system by a third set of individuals. The weights indicate importance of respective criteria from the set of criteria. The weights are received in the computer via a computer network. A set of evaluations are further received in the computer from a forth set of individuals. The evaluations correspond to possible attributes of the respective criteria. Membership of individuals is required in the respective sets of individuals before accepting their respective input. A relative analysis of the alternative choices is provided based on the set of evaluations and the set of weights. In an embodiment, a security identification that individuals are members of the respective sets of individuals is required before accepting their respective input.

An alternative embodiment provides a method for collaborative decision making. A set of alternative choices are received in a computer system coupled to a data network. The computer system also receives a set of criteria by which the set of alternative choices may be evaluated. A first set of individuals sends to the computer system via the data network a set of weights. Each weight indicates importance of a respective criterion from the set of criteria. The computer system further receives via-the data network a set of evaluations sent by a second set of individuals. Each evaluation corresponds to possible attributes of a respective criterion. Based on the set of evaluations, the set of weights and the identification of the individuals, a relative analysis of the alternative choices is provided.

For example, based on the identifier, the system may know that the individual is a specialist. Accordingly, the assessment of a specialist in a field corresponding to the respective criterion receives a stronger treatment. In a particular embodiment, at least a possible identifier is an identifier of a financial specialist, and the assessment of a financial criterion by a specialist receives a stronger treatment depending on the identifier of the specialist being the identifier of a financial specialist.

Another illustrative embodiment of the invention is a method for collaborative decision making. The method includes receiving in a computer system a set of alternative choices and a set of criteria by which the set of alternative choices may be evaluated. A set of assessments sent by a set of individuals via a data network coupled to the computer system are also received in the computer system. The assessments correspond to respective criteria from the set of criteria and comprise a set of weights that indicate importance of respective criteria from the set of criteria and a set of evaluations that correspond to possible attributes of the respective criteria. Based on the assessments, a relative analysis of the alternative choices is provided.

In an embodiment, the assessments include pairwise comparison combined with multiple choice. In another embodiment, the method the assessments include evaluation of alternatives using pairwise comparison combined with direct entry and multiple choice.

### BRIEF DESCRIPTION OF THE DRAWINGS

FIG. 1 shows a general overview of a distributed decision processing system in a computer network environment, according to an embodiment of the invention.

FIG. 2 shows a block diagram of elements of a distributed decision processing system, according to the embodiment of the invention.

FIG. 3 shows a block and flow diagram of various elements of a distributed decision processing system and its operation, according to an embodiment of the invention.

FIG. 4 shows a flow diagram of a distributed decision processing system including software modules corresponding to various participants in the decision-making process, according to an embodiment of the invention.

FIG. 5 shows a general flow diagram of the configuration and processes of a system for distributed decision making, according to an embodiment of the invention.

FIG. 6 shows another general flow diagram of the configuration and processes that take place in a system for distributed decision making, according to an embodiment of the invention.

FIG. 7 shows a schematic illustration of a distributed decision processing system including a criteria hierarchy, according to an embodiment of the invention.

FIG. 8A shows a schematic illustration of a distributed decision processing system, according to an embodiment of the invention.

FIG. 8B shows a graphical user interface for pairwise comparison evaluation according to an embodiment of the invention.

FIG. 8C shows another graphical user interface for pairwise comparison evaluation according to an embodiment of the invention.

FIG. 9 shows a schematic illustration of weighting of evaluation assessments according to an embodiment of the present invention.

FIGS. 10A-10J show screen examples from a user interface in a distributed decision processing system, according to an embodiment of the invention.

FIG. 11 illustrates various elements of a distributed decision processing system, according to an embodiment of the present invention.

FIG. 12 illustrates interconnection of various elements of a distributed decision processing system according to an embodiment of the present invention.

FIG. 13 illustrates another interconnection of various elements of a distributed decision processing system, according to an embodiment of the present invention.

FIG. 14 illustrates various layers of a distributed decision making processing system according to the present invention.

### DETAILED DESCRIPTION

A system provided by an embodiment of the present invention allows different users who may be at different locations and communicating via a data network, to play different roles and functions in a decision making process. The roles and functions of users may include definition of projects, identification of potential solutions and of parameters within which such solutions may be evaluated, and evaluation of the solutions. The roles of users may be tailored to solving particular problems or performing specific functions in the system, thereby providing advantages including increased functional parallelism, efficiency and accuracy in group decision making. Roles of users may include performing different functions in the group decision process, such as managerial tasks, including definition of the problem as well as tasks such as evaluation of alternatives and criteria. The system processes the information provided by users to either propose a solution to the problem, or to provide information to assist users in reaching a decision.

According to one embodiment of the invention, users identify a problem to be solved and enter information relevant to the problem. Then, users input possible solutions or alternatives to the problem. Users then identify relevant criteria to be used to compare possible solutions. Users also decide whether some criteria are more important than other criteria in the evaluation process. A number of users are then designated to assess how possible solutions to the problem rate according to each criterion under consideration. To do this, the assessing users consider each criterion individually and rate possible solutions. Once all the evaluations of the criteria have been performed, and once all the decisions regarding the relative importance of each criteria in the evaluation process have been completed, the system employs any of a number of evaluation methods to rank the possible solutions to the problem and synthesizes relevant data for final analysis.

One embodiment of the invention provides a system that enables a group of users to collaborate from different locations in a joint decision-making process. According to one embodiment of the invention, a system includes a software application that is accessible over the World Wide Web. Each user connects remotely through a Web browser (e.g., Internet Explorer or Netscape Communicator) to the application and interacts with the application.

In the decision making process described above, users may be assigned different roles depending on their expertise or familiarity with the problem or criteria under consideration. Certain users perform managerial functions, where they define possible solutions or appoint other users to certain positions (for example, a project manager may appoint a specific user to act as alternative manager, and the alternative manager may identify possible solutions to the problem). Other users may be assigned to act as evaluators for the criteria under consideration (for example, some users could be designated to act as evaluation assessors and would evaluate the possible solutions according to criteria).

In a particular embodiment, users access certain areas of the data processing system by connecting through a web browser and users may log in with specific user names and passwords assigned to them. The system automatically presents users with options and tasks that are appropriate for the respective user's functions in the decision making process. Various users may be assigned to perform a number of different functions (for example, a user may perform both managerial and non-managerial functions in the same project).

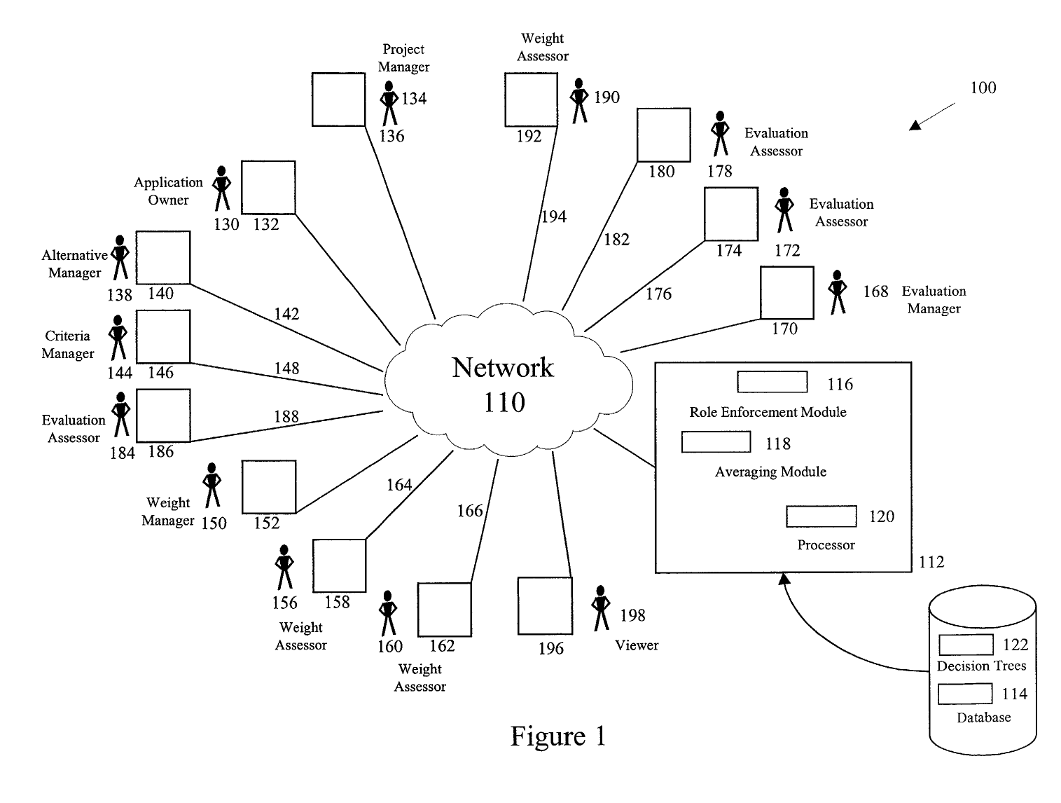

FIG. 1 shows a general overview of a distributed decision processing system in a computer network environment, according to an embodiment of the invention. Distributed decision making system 100 has a distributed system architecture that facilitates interaction between a central server and various users located remotely.

Distributed decision making system 100 includes, among other elements, a network 110 and a server 112 coupled to the network 110. In various embodiments, network 110 comprises an ethernet network, an intranet, a local area network (LAN), a metropolitan area network (MAN), a wide area network (WAN), or the World Wide Web (WWW). Also coupled to the network are various devices that facilitate access of corresponding human users to server 112, including application owner device 132, project manager device 136, weight assessor device 192, evaluation manager device 170, weighting manager device 152, criteria manager device 146, and alternative manager device 140. Coupled to network 110 is a plurality of weight assessor devices (e.g., weight assessor devices 158, 162 and 192). A plurality of evaluation assessor devices are also coupled to network 110 (e.g., evaluation assessor devices 174, 180 and 186).

The various individual users are able to access the distributed decision processing system through their respective devices. For example, project manager 134 can access the distributed decision processing system 100 via project manager device 136, application owner 130 can access system 100 through application owner device 132, and alternative manager 138 can access the distributed decision processing system 100 through alternative manager device 140. Also, criteria manager 144 can access system 100 through criteria manager device 146, weight manager 150 can access system 100 through weight manager device 152 and evaluation manager 168 can access system 100 through evaluation manager device 170. Weight assessors 156, 160 and 190 can access system 100 through weight manager devices 158, 162 and 192. Evaluation assessors 172, 178 and 184 can access system 100 through evaluation assessor devices 174, 180 and 186. Viewer 198 can access system 100 through viewer device 196.

Server 1112 includes processing functionality, software and storage to process alternatives based on respective criteria, weights and evaluations provided by various users. Accordingly, server 112 includes, among other elements, role enforcement module 116, averaging module 118 and processor 120. Database 114 is coupled to server 112 for storing, among other items, decision trees 122.

Distributed decision processing system 100 allows for the processing of decisions based on input of various individuals provided via network 110. Application owner 130 acts as an application administrator and generally ensures that the subsystems associated with data processing are operational and properly configured. Functions of application owner 130 include creating or deleting application users and defining access and security levels for users.

Project manager 134 acts as a project supervisor and generally manages the project and the activities of the users and evaluates the results. Functions of project manager 134 include creating a new project, defining project properties, assigning users to the project, assigning one or more roles to each user, assigning weighting rights to weighting assessors, assigning evaluator rights to evaluation assessors, analyzing the results of the evaluations, and managing the project status. Alternative manager 138 is responsible for identifying possible solutions to the problem under consideration and generally manages the alternatives for the project including adding, modifying and deleting alternatives.

Criteria manager 144 identifies various criteria by which the possible solutions (i.e., alternatives) to the problem are evaluated and generally manages those criteria. Functions of the criteria manager include arranging all criteria in a hierarchy. To arrange the criteria upon which the alternatives are scored in a logical and orderly manner, the criteria manager 144 builds one or more hierarchies (trees) consisting of one or more root criteria, node criteria (the branches) and final criteria (the leaves). Functions of the criteria manager also include designating fitting evaluation methods to final criteria, designating fitting weighting methods to node criteria, adding conditions to the criteria, adding tree conditions to the hierarchy, and finishing the hierarchy when it is complete. In an alternative embodiment of the invention, the criteria manager may appoint one or more node-criteria managers who may exercise analogous control over designated criteria sub-hierarchies.

Weights indicate the relative importance that various criteria have in the evaluation of alternatives. Weighting manager 150 identifies certain criteria to be compared by weighting assessors (e.g., weighting assessors 156, 160 and 190) and oversees the weighting process. After weighting assessors have finished weighting criteria, the weighting manager checks the weights allocated by weighting assessors and determines the final weight percentages of the criteria. Checking the weights allocated by the weighing assessors includes checking whether the weighting assessors have finished weighting, checking the consistency of each assessor's weight distribution, and checking the spread in weights of each criterion.

Weighting assessors (e.g., weighting assessors 156, 160 and 190) determine the relative importance of the criteria in the hierarchy by assigning relative weights to the criteria with the aid of different weighting methods. According to various embodiments of the invention, weighting methods include direct entry, pair wise comparison and multiple choice. The evaluation manager 168 checks evaluation outcomes entered by evaluation assessors. Evaluation manager 168 checks items among the following, for their respective leaf criteria: the average grade and arithmetic mean, the spread between the grades, the completeness of individual grades, and actual opinions, if necessary. Evaluation manager 168 also determines final grades granted to the alternatives.

Evaluation assessors (e.g., evaluation assessors 172, 178 and 184) evaluate the alternatives by establishing to what extent each alternative complies with the criteria that have been added to the project by the criteria manager. Evaluation assessors act upon criteria. Evaluation assessors use, according to various embodiments of the invention, different methods of comparison including direct entry, multiple choice, and pair wise companion.

Viewer 198 is authorized to view various types of information regarding the distributed decision making project. For example, viewer 198 may be authorized to view information regarding the identities of other users, alternatives, or criteria. In a particular embodiment of the invention, viewer 198 has no rights to change any information. In alternative embodiments, viewer 198 may modify selected information. In an embodiment of the invention, system 100 comprises an arbitrary number of viewer devices 196, and there are an arbitrary number of viewers 198. In alternative embodiments of the invention, users performing other roles in system 100 also act as viewers 198. For example, an evaluation assessor 172 may have rights to act as a viewer 198 to view certain information.

An embodiment of the present invention provides a method for collaborative decision making in which the computer system requires membership of individuals in the respective sets of individuals before accepting their respective input. A set of alternative choices are received in a computer system. These alternative choices are provided by a first set of individuals including at least one individual. The computer system also receives a set of criteria by which the set of alternative choices may be evaluated. The criteria are provided by a second set of individuals including at least one individual. A third set of individuals sends via a data network coupled to the computer system, a set of weights, which are received in the computer system. Each weight indicates importance of a respective criterion from the set of criteria. The third set of individuals comprises at least one individual. The computer system further receives via the data network a set of evaluations sent by a forth set of individuals. The forth set of individuals comprises at least one individual. Each evaluation corresponds to possible attributes of a respective criterion. The computer system requires membership of individuals in the respective sets of individuals before accepting their respective input. A relative analysis of the alternative choices is provided based on the set of evaluations and the set of weights. In an embodiment, the computer system requires a security identification that individuals are members of the respective sets of individuals, possibly including a password, before accepting their respective inputs.

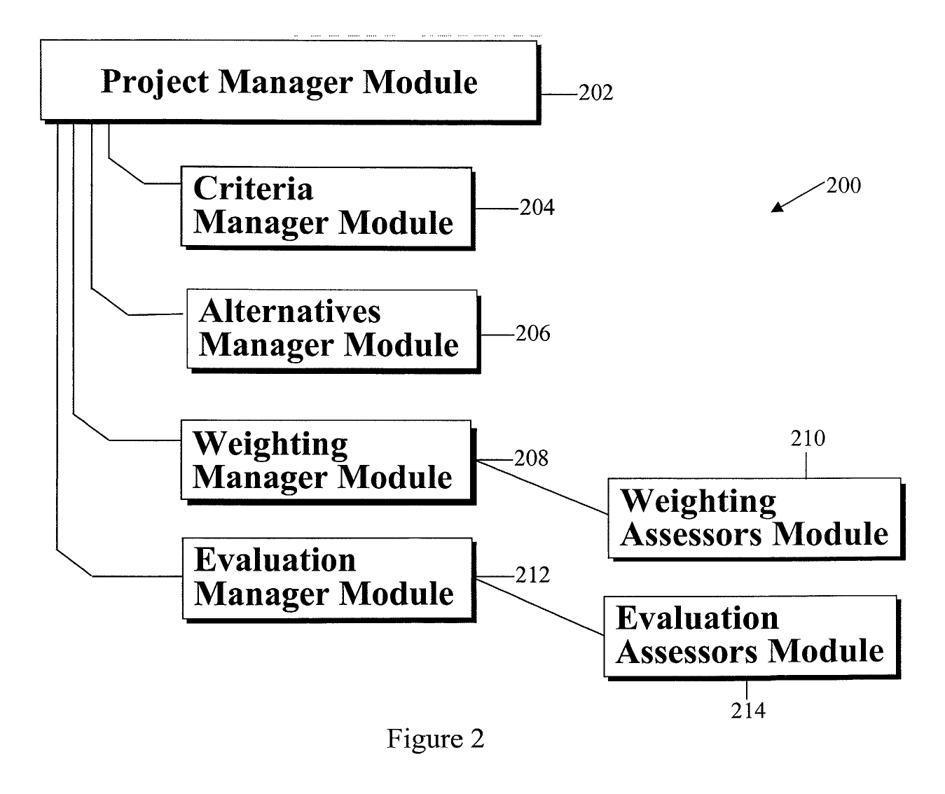

FIG. 2 shows a block diagram of elements of a distributed decision processing system, according to the embodiment of the invention. According to FIG. 2, project manager module 202 controls and manages functionality of various other modules within distributed decision processing system 200, including criteria manager module 204, alternatives manager module 206, weighting manager module 208, weighting assessors module 210, evaluation manager module 212 and evaluation assessors module 214. In certain embodiments of the present invention, the modules shown in FIG. 2 are implemented in an object oriented programming paradigm to relate information provided by, or corresponding to, users in distributed decision processing system 200, or are implemented through a combination of software and hardware components. Although these modules receive user input according to one embodiment of the invention, according to other embodiments, various of these modules may run without user input using software and/or artificial intelligence implementations.

Once weighting assessors module 210 indicate that users acting as weighting assessors have performed their functions, weighting manager 208 reviews their performance and evaluates the consistency of their results. Weighting manager 208 may choose to accept the judgements of weighting assessors 210, or may override their collective decision. Analogously, evaluation manager 212 reviews the opinions of evaluation assessors 214, evaluates their consistency, and decides whether to accept the group decision of evaluation assessors 214 or whether to override it either partially or completely.

After criteria manager 204, alternatives manager 206, weighting manager 208 and evaluation manager 212 complete their functions, project manager 202 has the option to either focus on their opinions and render a final decision on the issue under consideration, or review the individual opinion of another user, including that of weighting assessors 210 or evaluation assessors 214. Project manager 202 may choose to contact any user and discuss that user's particular decision with respect to a criterion or weight, or may choose to directly override that user's opinion. Project manager 202 has final authority to override the group decision.

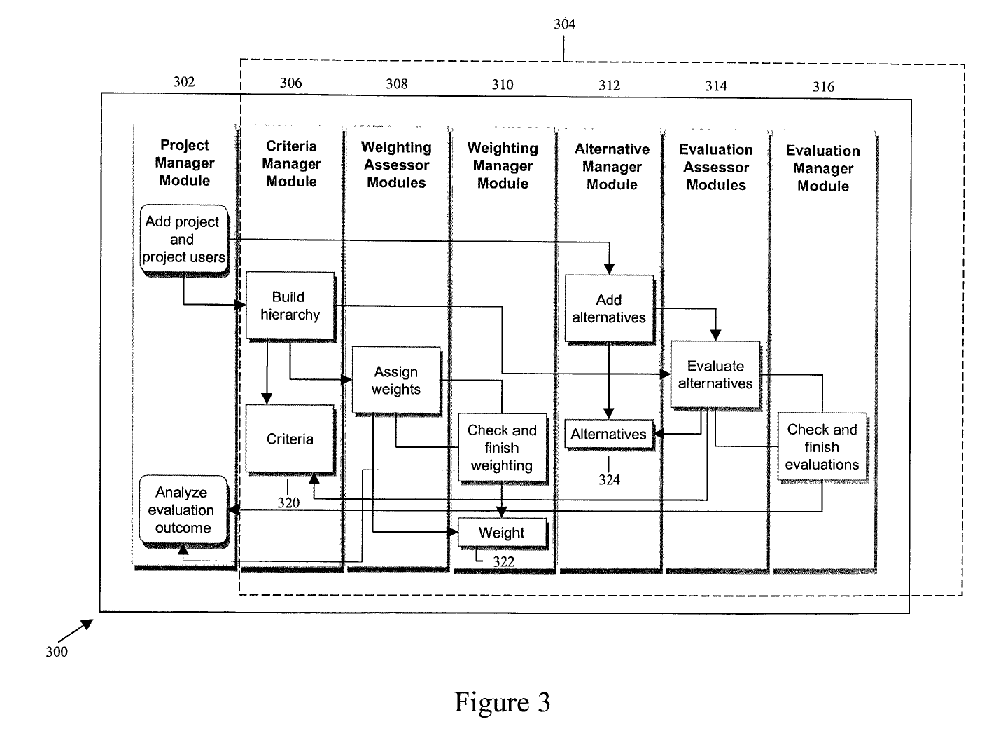

FIG. 3 shows a block and flow diagram of various elements of a distributed decision processing system and its operation, according to an embodiment of the invention. Functional hierarchy 300 shows various modules and their functions according to an embodiment of the present invention. In different embodiments, the modules shown in functional hierarchy 300 may comprise software or hardware logic for performing various functions, including functions shown in FIG. 3, or may perform such functions under direct control of corresponding human users. These modules perform various roles in serial or parallel processes and interact directly or through processing unit 318.

According to functional hierarchy 300, project manager module 302 controls definition of a project. Project manager module 302 defines operational parameters for evaluation subsystem 304, which comprises criteria manager module 306, weighting assessor modules 308, weighting manager module 310, alternative manager module 312, evaluation assessor modules 314 and evaluation manager module 316. In alternative embodiments, parameters defined by project manager module 302 include criteria 320, weights 322 and alternatives 324. These items may be implemented as data structures or other memory storage configurations.

Criteria manager module 306 arranges criteria 320 in a logical functional hierarchy to facilitate evaluation of the criteria by evaluation assessor modules 314, adds certain conditions to the criteria if necessary and indicates when the criteria hierarchy is complete. Weighting assessor modules 308 evaluate criteria 320 to asses the relative importance of each of criteria 320 in the collective decision making process. To achieve this, weighting assessor modules 308 assign weights 322 to each of criteria 320. Weighting manager module 310 reviews the entries of weighting assessor modules 308 and indicates when the weighting process of criteria 320 is complete.

Alternative manager module 312 manages alternatives 324 by adding, modifying or deleting information comprised therein. Once evaluation assessor modules 314 evaluate alternatives 324 with respect to criteria 320 and log the results of the evaluation, evaluation manager module 316 reviews the results and determines the final group evaluation results for criteria 320 with respect to alternatives 324. As previously mentioned, project manager module 302 has the authority to override the entries of evaluation manager module 316.

One advantage of the embodiment of FIG. 3 is parallelism in functionality and data processing, which may provide increased efficiency and expeditiousness in distributed group decision making. For example, alternative manager module 312 may define, modify or delete alternatives either before, simultaneously with, or after criteria manager module 306 arranges criteria 320 in a logical functional hierarchy, weighting assessor modules 308 assign weights 322 to each of criteria 320, or weighting manager module 310 reviews the entries of weighting assessor modules 308. As another example, evaluation assessor modules 314 may evaluate alternatives 324 with respect to criteria 320 either before, simultaneously with, or after modules 308 assign weights 322 to each of criteria 320 or weighting manager module 310 reviews the entries of weighting assessor modules 308.

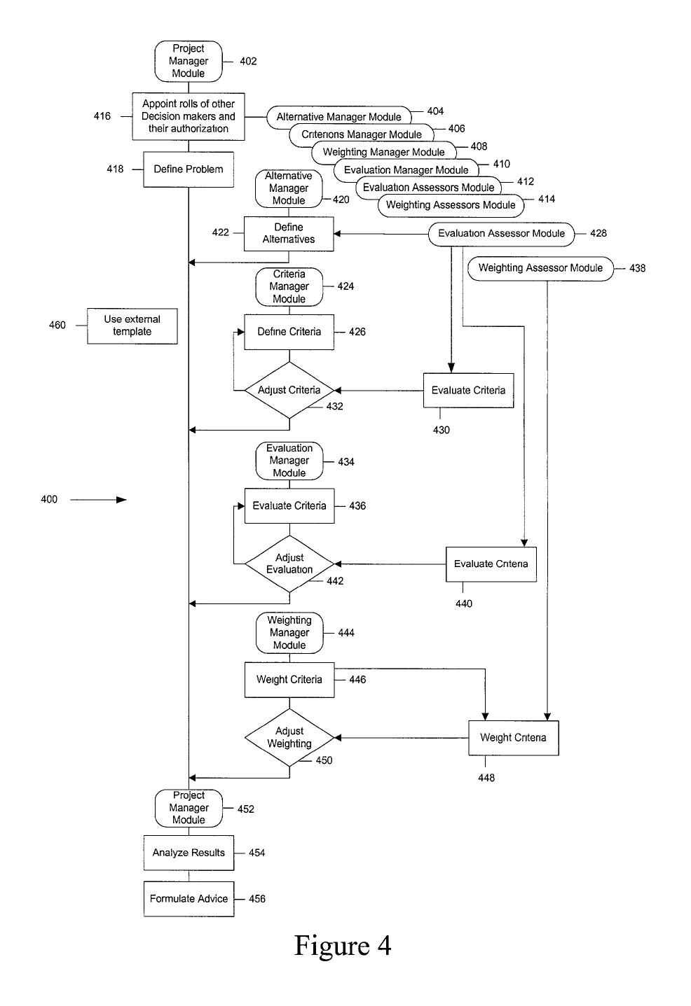

FIG. 4 shows a flow diagram of a distributed decision processing system including software modules corresponding to various participants in the decision making process, according to an embodiment of the invention. System 400 comprises a number of software or hardware modules that interact together and with human users to facilitate group decision making by a group of users at various locations.

System 400 includes project manager module 402, which controls the operation of a variety of other software modules in the system, including the definition of roles and authorizations for other decision making users (block 416). Project manager module 402 controls the operation of alternative manager module 404, criteria manager module 406, weighting manager module 408, evaluation manager module 410, evaluation assessors module 412 and weighting assessors module 414. Each of these modules receives information from users appointed to perform corresponding functions (e.g., alternative manager module 404 receives information from the alternative manager, criteria manager module 406 receives information from the criteria manager, weighting manager module 408 receives information from the weighting manager, evaluation manager module 410 receives information from the evaluation manager, evaluation assessors module 412 receives information from the evaluation assessors and weighting assessors module 414 receives information from the weighting assessors). In alternative embodiments, any particular user may perform any number of functions (e.g., the project manager may also act as criteria manager and as an evaluation assessor). Also, in alternative embodiments, any single function may be shared by multiple users who could either cooperate in making any specific decision or may delegate a specific user to act on their behalf (e.g., multiple users may be assigned to act as evaluation managers).

Project manager module 402 also stores information identifying the problem to be resolved (block 418). Once the problem to be resolved is identified, alternative manager module 420 receives information regarding the alternatives to be considered (e.g., possible solutions to the problem) (block 422). Criteria manager module 424 receives information regarding the criteria to be considered in evaluation of the alternatives (block 426).

Evaluation assessors module 428 controls evaluation of the criteria (block 430) in reference to the alternatives defined by alternative manager module 420 (block 422). Evaluation assessors connect to system 400 and interact with evaluation assessors module 428 to view the alternatives and criteria previously entered into the system. The alternatives and criteria that evaluation assessors view are transmitted to evaluation assessors module 428 by alternative manager module 420 and, respectively, criteria manager module 424. The evaluations provided by the evaluation assessors (block 430) are communicated to alternative manager module 420. In an embodiment of the invention, evaluation assessors only evaluate end criteria, which, by definition, are criteria without any dependent sub-criteria.

Criteria are adjusted in response to evaluation of the criteria (block 432). A feedback loop provides the ability to redefine the criteria in case the existing criteria are not adequate for the decision process (block 432). Such a situation may exist, for example, when criteria manager module 424 assesses that the criteria presented to evaluation assessors module 428 would not lead to a sufficiently accurate result and that replacement or addition of certain criteria could resolve that problem.

Evaluation manager module 434 oversees evaluation of the criteria. Evaluation manager module 434 evaluates the criteria (block 436) and determines the appropriate methods for evaluation of the criteria (block 442). Evaluation manager module 434 may define different evaluation methods for different criteria, depending on various factors, including, for example, the degree of subjectivity associated with particular criteria under consideration and the particular characteristics of the alternatives under consideration. Once evaluation manager module 434 defines the methods for evaluation of the criteria (block 442), evaluation assessors module 410 evaluates the criteria.

Evaluation manager module 434 analyzes the results of this evaluation and decides whether to adjust the results of this evaluation (block 442) or whether to modify the evaluation methods (block 442) available to evaluation assessors module 428, thereby creating an evaluation feedback loop. According to an embodiment of the present invention, evaluation managers may employ a variety of methods to evaluate criteria, depending on the nature of the alternatives and criteria under consideration. Different evaluation methods may be appropriate under various circumstances, depending, among other factors, on the expertise of the evaluation assessors or the inherent degree of subjectivity associated with a particular criteria to be considered. The evaluation manager defines the specific evaluation methods to be used with respect to any criterion or alternative and enters this information into evaluation manager module 434.

After a sufficient number of iterations in this evaluation feedback loop, evaluation manager module 434 may decide that the evaluation of the criteria by evaluation assessors module 428 is sufficiently accurate, and may make these results available to project manager module 452 for final analysis.

Weighting manager module 444 oversees determination of the relative importance of criteria in the evaluation process. Weighting manager module 444 identifies the criteria to be weighted (block 446), submits these weights for evaluation to weighting assessors module 438, and controls the weighting process. Weighting assessors module 438 assesses the relative importance of the criteria in the evaluation process by assigning weights to the criteria (block 448). Once weighting assessors module 438 completes weighting of the criteria, weighting manager module 444 assesses the weights and chooses whether to adjust the weights (block 450) or whether to modify the weighting method available to weighting assessors module 438 (block 450), thereby creating a weighting feedback loop. Weighting manager module 444 completes its function by making the weights available to project manager module 452 for final analysis.

Project manager module 452 oversees the operation of various other modules in the system and either performs or assists with final evaluation of the results. Upon conclusion of intermediate evaluations, the results provided by criteria manager module 424, evaluation manager module 434 and weighting manager module 444 are used by system 400 to determine grades for various criteria and alternatives. These grades are communicated to project manager module 452. Project manager module 452 evaluates and analyzes these grades (block 454). Project manager module 452 may either accept the results of the evaluation process, or may modify these results. Project manager module 452 either formulates advice on the problem under consideration (block 456), or provides the final results, a summary of the information provided by the other manager software modules, or the comprehensive set of decisions made by each individual to the project manager for further analysis, in which case the project manager formulates advice (block 456).

A method for decision making according to an embodiment of the present invention includes performing a sensitivity analysis. A sensitivity analysis may involve adjustment of various parameters in the system, including weights or grades. In a particular embodiment, a sensitivity analysis may indicate whether adjustment of weights provided by weighting manager module 444 impacts the final grades assigned to alternatives by evaluation manager module 434, and if so, to what extent. In an embodiment of the invention, an “analysis to root” permits analysis of the extent to which the weighting percentages of particular criteria affect the final grades assigned to alternatives with respect to the corresponding criteria. In one embodiment, an analysis to root permits a user to modify weights assigned to different criteria within a criteria tree to observe corresponding changes in the grades and ranking of alternatives. Among other advantages, this provides a tool for fine tuning the methods employed in an embodiment of the present invention.

Following is an example of operation of the embodiment shown in FIG. 4. In this example, the problem to be resolved is the selection of a new computer to be purchased. Users of system 400 perform different roles and functions in this group decision making process. For example, an alternative manager identifies possible solutions to the problem under consideration (e.g., different models to be considered), a project manager selects various users who participate in the decision process, a criteria manager selects criteria that serves as a basis for evaluation of alternatives (e.g., price or performance), a weighting manager oversees determination by weighting assessors of how important criteria are in the evaluation process (e.g., whether price of the computer is more important than the performance of the computer) and evaluation assessors express their relative preferences for the possible solutions with respect to each criteria (e.g., a user rates various computers based on performance).

The project manager defines this problem (i.e., selection of a new computer) by entering appropriate information into project manager module 402 (block 418). Depending on the nature of the problem to be solved, the project manager selects users with appropriate expertise for their intended functions and enters this information into project manager module 402. For example, here the evaluation manager may be a person familiar with various computer models available commercially and have an understanding of the general requirements that the new computer must satisfy. Following an analogous selection process, the project manager appoints all the remaining users to proper functions and enters the relevant information in project manager module 402.

Project manager module 402 then communicates this information to the appropriate software modules of the application and defines roles and authorizations for each individual user. For example, to appoint a criteria manager, the project manager identifies a specific user to act as the criteria manager and assigns to this user corresponding rights and duties. Then, the project manager enters into project manager module 402 information relating to the identity, rights, duties and scope of authority of the new criteria manager. Project manager module 402 communicates relevant parts of this information to criteria manager module 424. Project manager module 402 also utilizes such information to control the functionality of evaluation manager module 434 during the decision making process.

In this example, assume that the alternatives manager defines two alternatives, “computer A” and “computer B,” and enters this information in alternative manager module 420. Further assume that the criteria manager identifies performance and price as the relevant criteria for comparison of computers A and B and enters this information in criteria manager module 424. The criteria manager may choose to divide certain criteria into sub-criteria to facilitate the evaluation of the criteria. In this example, the criteria manager may divide performance into two sub-criteria: microprocessor speed and general assessor impression. The criteria manager then enters this information into criteria manager module 424. Criteria manager module 424 utilizes this information to control the functionality of evaluation assessors module 428 with regard to each individual evaluation assessor.

In this example, the evaluation assessors compare computers A and B according to three end criteria: microprocessor speed, general assessor impression and price. Once evaluation assessors enter their opinions into evaluation assessors module 428 regarding computers A and B with respect to the three criteria (block 430), their opinions are communicated to criteria manager module 424, where they are reviewed by the criteria manager. The criteria manger may decide that the evaluations made by the evaluation assessors are inadequate and may choose to define additional criteria (e.g., speed of memory), or may choose to modify the existing criteria (e.g., define sub-criteria for the “general assessor impression” criterion). The criteria manger enters any changes into criteria manager module 424, which then directs evaluation assessors module 428 to prompt some or all of the evaluation assessors to evaluate the criteria again (block 430). This feedback process continues until criteria manger module 424 indicates to evaluation assessors module 428 that adjustment of the criteria is complete and that the criteria are locked.

Criteria manager module 424 may define various evaluation methods to be provided to weight assessors. For example, when comparing the computers based on the “general assessor impression” criterion, which is a subjective measure, criteria manager module 424 may indicate to evaluation assessors module 428 to present certain evaluation assessors with a multiple choice selection: “Choose either computer A or computer B” (block 440). Evaluation assessors module 428 would then transmit a binary choice of the respective evaluation assessor. In contrast, for the “price” criterion, if the difference in price between the two computers is small, criteria manager module 424 may direct evaluation assessors module 428 to present certain evaluation assessors with a question designed to measure those assessors' relative preference for the two computers: Please rate each computer on a scale from 0 to 10.” An evaluation assessor may respond to this question by indicating to evaluation assessors module 428 a grade of 8 for computer A and a grade of 4 for computer B (block 440). Evaluation assessors module 428 transmits all the opinions it records to evaluation manager module 434, which may adjust the results of the evaluations or the evaluation methods if appropriate.

In the embodiment of FIG. 4, weighting manager module 444 identifies the weights to be assigned to the criteria under consideration. In the current example, weighting manager module 444 may indicate that weights must be determined for the sub-criteria of performance (i.e., microprocessor speed versus general assessor impression), and for the criteria performance versus price. Weighting assessors module 438 then indicates the opinions of the weighting assessors who compare the criteria. In this example, weighting assessors module 438 might indicate that general assessor impression is five times more important than microprocessor speed and that price has a 60% degree of importance compared to performance, while performance has a 40% degree of importance. The weighting manager may choose to accept these weights as assigned by the weight assessors, or may direct weighting manager module 444 to modify them. For example, the weighting manager may decide that the weighting assessors discounted the importance of the performance of the computer too much, and may direct weighting manager module 444 to modify the weights for the general assessor impression and microprocessor speed criteria to only reflect a preference ration of three to one.

Depending on the configuration of system 400, project manager module 452 may automatically evaluate which of the two computers should be selected based on the information presented to it (block 454) and may provide a suggestion (block 456). Alternatively, or simultaneously with its automatic evaluation of the data, project manager module 452 may display the relevant information to the project manager, in which case the project manager analyzes the results (block 454) and formulates a recommendation (block 456). In the current example, depending on the information provided by criteria manager module 424, evaluation manager module 434 and weighting manager module 444, project manager module 452 may recommend that computer A be selected over computer B.

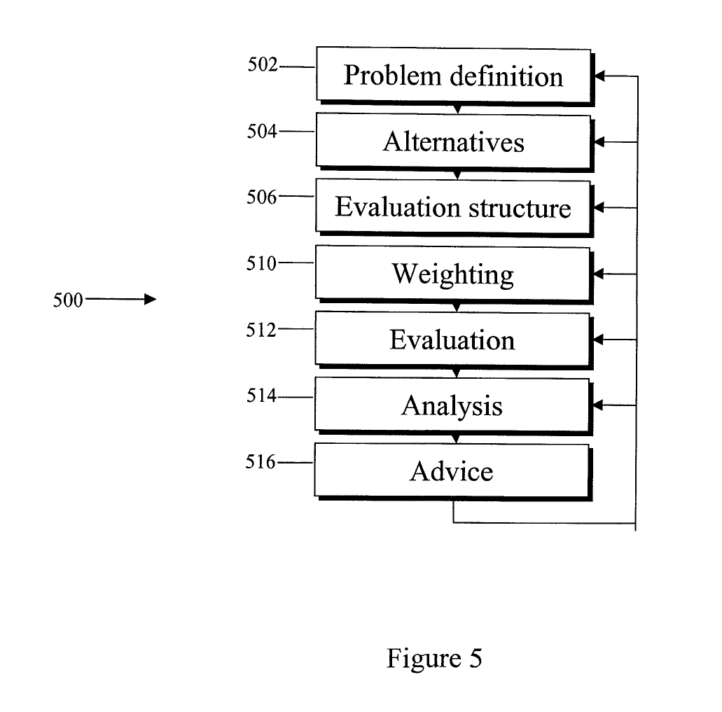

FIG. 5 shows a general flow diagram of the configuration and processes of a system for distributed decision making, according to an embodiment of the invention. Such configuration and processes may be implemented through a computer system running a software application with corresponding logic implemented in software code, or in a hardware system or combination of hardware and software where elements are implemented in hardware logic or a combination of hardware and software logic. System 500 is initially configured to identify the problem or issue to be decided (block 502). Subsequently, the alternatives that identify possible solutions to the problem are entered into system 500 (block 504). Next, the criteria to be employed in the evaluation of the alternatives are entered into system 500, thereby defining an evaluation framework for the alternatives (block 506). Next, the criteria to be weighted are identified and the corresponding weights are computed. Since the criteria may be organized in a tree structure, including root, node and leaf criteria, weighting may take place at different levels within the tree (block 510). The alternatives are then evaluated (block 512) with the assistance of system 500.

Definition of the criteria evaluation structure (block 506), weighting of the criteria at different levels (block 510), and evaluation of the alternatives (block 512) may take place in the order shown, according to one embodiment, or in any order, as they are independent of each other. This illustrates some of the advantages of this embodiment: functions can be implemented and performed in parallel by different users, thereby providing a high degree of flexibility to the different individuals participating in the group decision making process. Additionally, this can help significantly increase the efficiency and speed with which a group decision is made because individual users may perform their functions without waiting for other users to complete other activities.

Once the processes described above take place, analysis of data provided by various software modules of system 500 takes place (block 514). Depending on the results of the analysis, system 500 provides final advice on the alternatives under consideration, or assists the project manager in making a final recommendation (block 516).

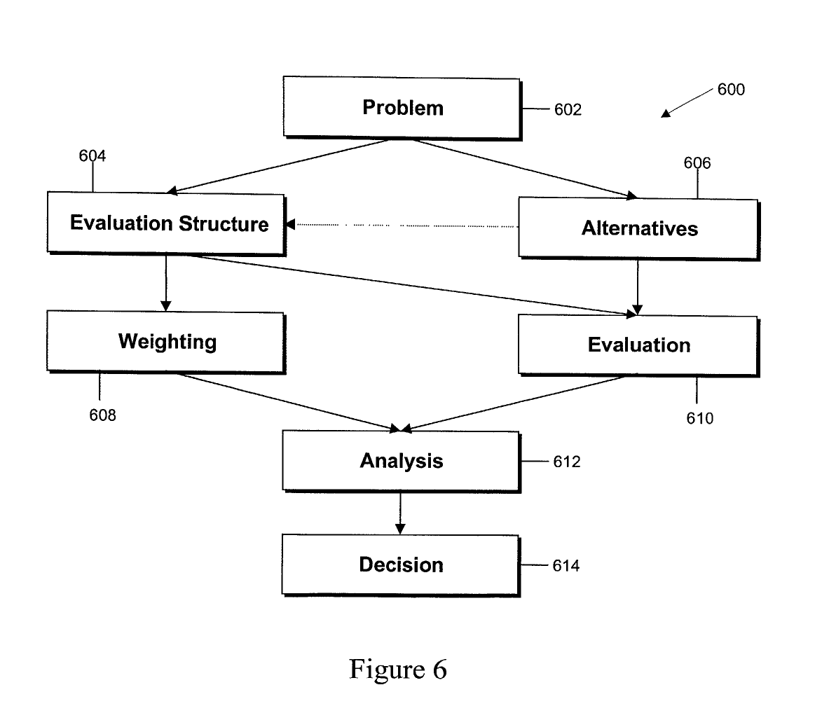

FIG. 6 shows another general flow diagram of the configuration and processes that take place in a system for distributed decision making, according to an embodiment of the invention. Problem 602 is initially identified and defined in system 600. Next, criteria evaluation structure 604 and alternatives 606 are identified and entered into system 600. Next, the criteria comprised in criteria evaluation structure 604 are weighted (block 608). Either before, simultaneous with, or subsequent to weighting of the criteria comprised in criteria evaluation structure 604, evaluation of criteria evaluation structure 604 takes place with the assistance of system 600 (block 610). The results of the evaluation and of the weighting of criteria evaluation structure 604 are then employed by system 600 in the analysis process (block 612) to render a final decision or to provide the relevant information to a project manager who may make the final decision (block 614).

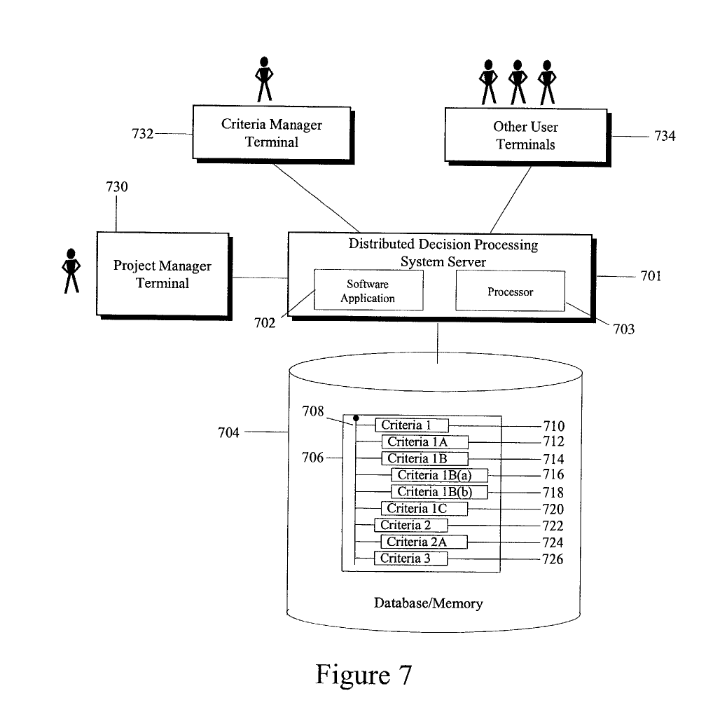

FIG. 7 shows a schematic illustration of a distributed decision processing system including a criteria hierarchy, according to an embodiment of the invention. Distributed decision processing system 700 comprises server 701, which hosts software application 702. Software application 702 manages the group decision making process by controlling the activities and rights of each individual participating in the decision making process. Server 701 comprises processor 703, which runs software application 702. In an alternative embodiment, processor 703 comprises multiple processors, providing parallel processing functionality to software application 702. In yet another alternative embodiment, processor 703 resides remotely from server 701, and software application 702 runs on processor 703 by establishing a remote connection. In still another embodiment, processor 703 comprises multiple processors, some but not all of which are located remotely from server 701, and software application 702 runs in parallel on processors located both within server 701 and remote with respect to server 701.

Server 701 is coupled to database 704 which stores information pertaining to the decision making process, including identities, authorizations and functions of users. In one embodiment, database 704 is located remotely from server 701, in which case server 701 and software application 702 communicate remotely with database 704. In an alternative embodiment, server 701 comprises database 704, in which case software application 702 interacts locally with database 704.

Database 704 comprises memory area 706 which stores various types of information used by software application 702, including identities, authorizations and functions of users.

In an embodiment of the invention, certain criteria are divided into sub-criteria to facilitate evaluation by evaluation assessors. Under certain circumstances, complex criteria may be subdivided into simpler sub-criteria that may be easier to evaluate. For example, a criterion “speed of a computer” may be subdivided into multiple sub-criteria, including “speed of the processor,” “Speed of the cache memory,” “amount of Random Access Memory,” “Speed of the Random Access Memory” and “speed of the processor data bus.” Division of criteria into sub-criteria may help evaluation assessors provide more objective evaluations by focusing on more discrete and concrete sub-criteria. According to an embodiment of the invention, the system combines such evaluations of sub-criteria to determine weighted averaged evaluations for parent criteria.

Memory area 706 comprises criteria hierarchy 708, which comprises a number of exemplary criteria trees. In one embodiment of the invention, criteria trees comprise such sub-criteria into which respective criteria are sub-divided. In one embodiment of the invention, criteria trees comprise criteria used to evaluate alternatives. In general, trees constitute a type of hierarchical data structure in which elements at various levels in the hierarchy are directly coupled only with elements in the level immediately superior or inferior. Among a pair of elements connected in a tree, the element in the superior hierarchical level is conventionally identified as a “parent element” and the element in the inferior hierarchical level is identified as a “child element.” By convention, trees have a single element in the top hierarchical level, identified as a “root element.” Elements that are connected to other elements in inferior hierarchical levels are identified as “branch elements” or “node elements.” Branch elements have both parent elements and child elements. Elements that are not connected to any child elements are identified as “end elements” or “leaf elements.” According to one embodiment of the invention, such leaf elements are evaluated by evaluation assessors. For example, in the example above, the evaluators may evaluate leaf criteria, “speed of processor” and the root criterion “speed of computer” may be automatically generated based on the leaf criteria and other criteria.

Criteria hierarchy 708 comprises three types of criteria: root criteria, node criteria and end criteria. In the exemplary embodiment of FIG. 7, criteria hierarchy 708 comprises three root criteria: criterion 1 (block 710), criterion 2 (block 722) and criterion 3 (block 726). Node criteria, alternatively identified as “branches,” are criteria that have both parent and child criteria. Node criteria may depend on root criteria or on other node criteria. Criteria depending on a node criterion may be other node criteria or end criteria (defined below). Criteria hierarchy 708 comprises one node criterion, criterion 1B (block 714), which depends on root criterion 1 (block 710). Criterion 1B has two dependent end criteria, criterion 1B(a) (block 716) and criterion 1B(b) (block 718).

Criteria hierarchy 708 comprises five end criteria: criterion 1A (block 712), which depends on root criterion 1 (block 710); criterion 1B(a) (block 716), which depends on node criterion 1B (block 714); criterion 1B(b) (block 718), which depends on node criterion 1B (block 714); criterion 1C (block 720), which depends on root criterion 1 (block 710); and criterion 2A (block 724), which depends on root criterion 2 (block 722).

FIG. 7 also shows a number of user terminals which are coupled to server 701 and communicate with software application 702, including project manager terminal 730, criteria manager terminal 732 and other user terminals (collectively represented as block 734). Each of these terminals facilitates communication between their corresponding users and software application 702. For example, project manager terminal 730 enables a project manager to appoint a criteria manager, and criteria manager terminal 732 allows the criteria manager to define and construct criteria hierarchy 708.

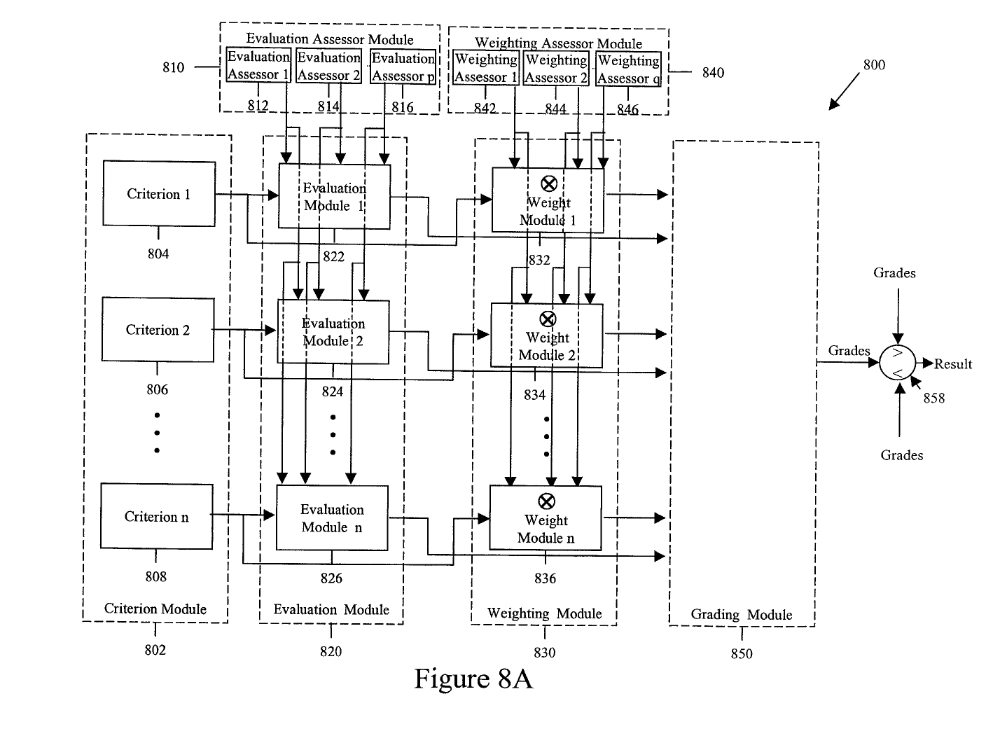

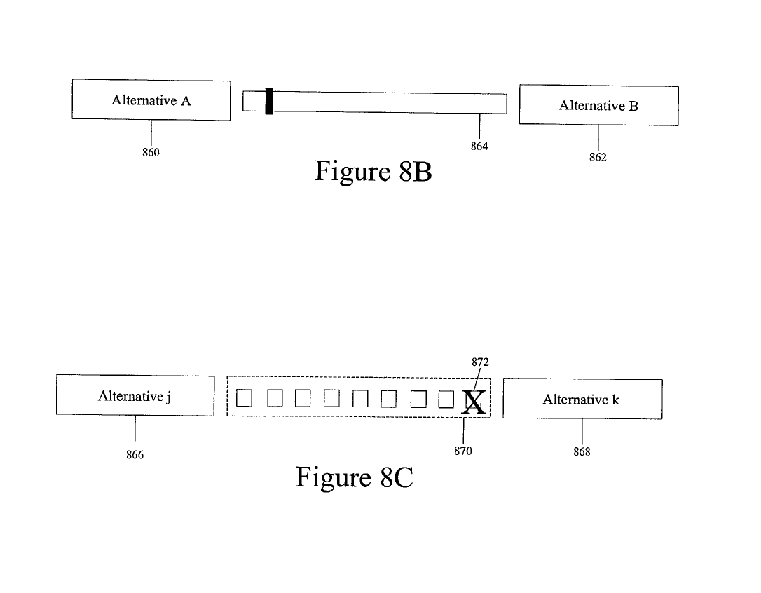

FIG. 8A shows a schematic illustration of a distributed decision processing system, according to an embodiment of the invention. The embodiment of FIG. 8A illustrates a system for processing of data provided by various users, including evaluation assessors and weighting assessors, according to an embodiment of the present invention. Various modules in FIG. 8A receive information from human users and transmit it to other modules for further processing. A final analysis of the information provided by human users is provided by the system, possibly including a ranking of alternatives and a final recommendation.

Decision processing system 800 comprises criterion module 802, evaluation assessors module 810, evaluation module 820, weighting module 830, weighting assessor module 840 and grading module 850. These modules represent successive stages that process information provided by different decision making users in the system to produce a final decision.

Criterion module 802 stores information identifying a particular criteria tree to be used in evaluating the alternatives. The criteria tree corresponds to a specific root criterion. A goal of system 800 is to determine a grade for a set of alternatives under consideration with respect to the root criterion.

In this embodiment, criterion module 802 includes a number of criteria denoted by “n,” which are illustratively shown as criterion 1 (block 804), criterion 2 (806) and criterion n (808). The number of criteria may be selected according to the characteristics of the decision process under consideration. Each of the criteria comprised in criterion module 802, including criterion 1 (block 804), criterion 2 (806) and criterion n (808), may be a node criterion or an end criterion. Evaluation module 820 evaluates criteria in corresponding software modules illustratively denoted in FIG. 8A as evaluation module 1 (822), evaluation module 2 (824) and evaluation module n (826). In an embodiment of the invention, evaluation module 820 only acts upon end criteria. Consequently, in that embodiment, evaluation module 820 does not evaluate root criteria and node criteria, and therefore such criteria pass through or completely bypass evaluation module 1 (822), evaluation module 2 (824) and evaluation module n (826) without being evaluated.

Evaluation assessor module 810 stores information regarding evaluation assessors who are assigned to evaluate the criteria and allows them to record their opinions regarding the criteria. In the embodiment of FIG. 8A, evaluation assessor module 810 stores information regarding a number of evaluation assessors denoted by “p,” including evaluation assessor 1 (812), evaluation assessor 2 (814) and evaluation assessor p (816). Each evaluation software module comprised in evaluation module 820 receives inputs from some or all of the evaluation assessors corresponding to evaluation assessor module 8 and processes this information to derive opinions for the corresponding alternatives with respect to the corresponding criterion. For example, in the embodiment of FIG. 8A, evaluation module 1 (822) receives from evaluation assessor module 810 information regarding each evaluation assessor, including evaluation assessor 1 (812), evaluation assessor 2 (814) and evaluation assessor p (816). Each evaluation assessor module performs one or more evaluations depending, among others, on the number of alternatives under consideration and on the method of evaluation employed.

In one embodiment evaluation module 820 quantifies the opinion of each evaluation assessor with respect to each criterion and stores this information in a vector with dimensions (r)x(1), where r represents the number of alternatives under consideration. For example, if evaluation assessor 1 (812) expresses opinions with respect to three alternatives for criterion 1, evaluation module 1 (822) produces a (3)×(1) vector which may include the following exemplary components:

W1=[0.2, 0.5, 0.5, 0.3]^{T}.

Values entered by evaluation assessors are converted to actual grades according to one or more methods predefined by the project manager, as further described below.

The project manager also defines a spread indicator interval. The spread indicator indicates the consistency of the opinions expressed by evaluation assessors regarding a particular alternative with respect to corresponding criteria. The project manager may also determine the accuracy with which grades are stored and processed in the system. For example, the project manager may require that all grades be rounded off and processed as integer numbers, or may permit evaluation of grades with an arbitrary number of decimals.

According to alternative embodiments of the present invention, evaluation module 820 may employ one or more of the following methods to quantify the opinions of the evaluation assessors transmitted by evaluation assessor module 810: direct entry, multiple choice, or pairwise comparison. A criteria manager determines which of these three methods will be used by any particular evaluation assessor with respect to any given criteria.

According to an embodiment of the present invention, evaluation of alternatives with respect to criteria is processed in two distinct domains: an evaluation value domain and a grade domain. The evaluation domain includes information provided by evaluation assessors, possibly in a numerical format (e.g., speed of a car in miles per hour). The grade domain comprises numerical grades employed by the system to quantify the evaluations provided by evaluation assessors in a numerical format that is more suited for data processing according to an embodiment of the invention.

Depending on the evaluation method employed by evaluation assessors, the opinions of the evaluation assessors may be assigned evaluation values in the evaluation domain. The evaluation values are then mapped into grades in the grade domain. Translation between the evaluation domain and grade domain depends upon the evaluation method employed by evaluation assessors and may employ a value function. In an embodiment of the invention, the evaluation domain is characterized by an evaluation range defined by absolute minimum and absolute maximum evaluation values and by an effective sub-range comprised within the evaluation range. In an alternative embodiment, the grade domain is marked by a minimum grade, a cutoff grade and a maximum grade.

In one embodiment of the invention, the direct entry method for evaluation of criteria translates evaluation values associated with the opinions of evaluation assessors directly into grades, the multiple choice method links specific choices selected by evaluation assessors to predefined grades and the pairwise comparison method employs an intermediate step in conversion of opinions of evaluation assessors into grades.

The direct entry method for evaluation of criteria allows an evaluation assessor to enter directly a relevant value for a particular alternative with respect to any specific criterion (e.g., price in Euro, weight in kilograms, delivery time in days, or percentage of discount). The criteria manager defines certain parameters for the direct entry method, including the absolute minimum and maximum for the evaluation range within which the evaluation value entered must fall.

Within this evaluation range, the criteria manager may further define a minimum value and a maximum value marking an effective sub-range within which the evaluation value entered and mapped into a grade by a value function with a corresponding curvature figure. If an evaluation value falls outside this sub-range, it automatically receives a minimum or a maximum grade, depending on whether the evaluation value falls below the minimum value, or respectively, above the maximum value of the sub-range. For example, the criteria manager may indicate that although the absolute minimum value for the price of a car is $10,000, in which case a price of $10,000 would score a maximum grade of 10, any price value between $10,000 and $13,000 also receives a grade of 10. By defining a sub-range within the evaluation value range, the criteria manager essentially compresses the numerical evaluation scale.

The criteria manager may also define a value function which controls the mapping of evaluation values into grades. The value function only pertains to the effective sub-range determined by the minimum and maximum values described above. In an embodiment of the invention, among parameters defining a value function, the criteria manager may select a cut-off grade, a normalization direction, a function shape and a function curvature.

In one embodiment of the invention, the cut-off grade identifies the lowest grade that may be compensated, i.e., the lowest grade that is not automatically reset to the minimum possible grade. Whenever evaluation values map to grades below the cut-off grade, such evaluation values receive a grade equal to the minimum possible grade. In an alternative embodiment, the cut-off grade identifies the highest grade that may be compensated, i.e., the highest grade that is not automatically reset to the maximum possible grade. In that embodiment, whenever evaluation values map to grades above the cut-off grade, such evaluation values receive a grade equal to the maximum possible grade.

The criteria manager may also indicate a normalization direction and curvature for translation of values entered by evaluation assessors into grades. In one embodiment, this decision may be made before determination of the characteristics of the value function. The normalization direction indicates whether higher values receive higher grades (i.e., upward normalization) or lower grades (i.e., downwards normalization). For example, if a value entered represents price, a higher price receives a lower grade, and therefore downward normalization would be appropriate in this case. In contrast, if a value entered represents the frequency at which a microprocessor operates, a higher value receives a higher grade, and therefore upward normalization should apply.

The curvature of the value function controls the mapping of the direct entry values domain into the grade domain. For a value function with zero curvature (i.e., a straight line), values entered are linearly mapped into grades. For a concave curvature, the value function approaches the higher end of the value range asymptotically, thereby decreasing the sensitivity of translation of entries into scores at the higher end. For example, for a concave value function, a relatively large range of higher prices is mapped into a relatively narrow range of low grades, such that all prices beyond a certain threshold receive relatively low grades. In contrast, a convex curvature decreases the sensitivity of translation of entries into scores at the lower end. In alternative embodiments, the criteria manager may define more complex value functions, including, for example, trigonometric or polynomial functions of arbitrary degree. By defining one or more of the parameters described above, the criteria manager determines a mapping function for converting the values entered directly by evaluation assessors into grades.

In an alternative embodiment, the evaluation manager selects multiple choice as the evaluation method to be employed by evaluation module 820 to quantify the opinions of the evaluation assessors transmitted by evaluation assessor module 810. The criteria manager configures evaluation assessor module 810 to present the evaluation assessors with a set of multiple choices, and assigns to each of these choices a particular grade. For example, an evaluation assessor may be presented with the choices “good” and “bad” with respect to a criterion (e.g., brightness) for a particular alternative (e.g., a particular liquid panel display). If the evaluation assessor evaluates that particular alternative as “good,” evaluation module 820 may assign a grade of 10 to that alternative with respect to that criteria on a scale from 0 to 10. In contrast, a “bad” evaluation may be graded as 0.

Pairwise comparison represents another method for quantification of the opinions of the evaluation assessors by evaluation module 820 according to an embodiment of the present invention. Pairwise comparison provides evaluators with pairs of alternatives for each criteria and requests that evaluators indicate their relative preferences for the two alternatives in each pair. This method of comparison has the potential to make the evaluation process easier for the evaluation assessors and more accurate because the assessors do not need to estimate and enter numerical values, as in the direct entry evaluation method, or select from a limited number of choices, as in the multiple choice selection method. Instead, according to the pairwise comparison evaluation method, the evaluation assessors express their preferences in relative terms for pairs of alternatives by indicating which of the two alternatives is more appealing, and by what relative amount. The evaluation assessors may express their opinions by graphically adjusting a sliding scale as shown in FIG. 8B, or by checking a box as illustrated in FIG. 8C.

FIG. 8B shows a graphical user interface for pairwise comparison evaluation according to an embodiment of the invention. The graphical user interface of FIG. 8B provides an evaluation assessor with the ability to intuitively adjust sliding bar 864 on a continuous scale to indicate a relative preference for a pair of alternatives under consideration. In the embodiment of FIG. 8B, an evaluation assessor employs pairwise comparison to indicate a strong preference for alternative A (860) as compared to alternative B (862) by adjusting sliding bar 864.

FIG. 8C shows another graphical user interface for pairwise comparison evaluation according to an embodiment of the invention. The interface of FIG. 8C allows an evaluation assessor to indicate relative preferences for a pair of alternatives under consideration by selecting from a discrete spectrum of checkboxes comprised in checkbox set 870. In the embodiment of FIG. 8C, an evaluation assessor employs pairwise comparison to indicate an absolute preference for alternative k (868) by selecting the checkbox closest to alternative k (868) in checkbox set 870 (i.e., checkbox 872).

In a particular embodiment of the invention, the relative preferences of an evaluation assessor employing pairwise comparison are graded in relative percentages by distributing a total of 100% over the alternatives, proportionally to the opinions of the evaluation assessors. In an alternative embodiment, the opinions of an evaluation assessor regarding alternatives are translated into grades comprising dimensionless numbers which may not necessarily represent percentages.

The following example illustrates the manner in which evaluation module 820 quantifies the responses of evaluation assessors using pairwise comparison according to an embodiment of the invention. According to this example, an evaluation assessor expresses relative preferences for three alternatives with respect to a specific criterion. The alternatives are denoted as A1, A2 and A3. The three alternatives are combined to form a total of three non-redundant pairs. In general, an arbitrary number n of alternatives may be combined to form a total of n*(n−1)/2 distinct pairs.

The criteria manager defines a quantification scale for the relative preferences that evaluation users may express with respect to any particular pair of criteria. For example, with respect to the pair of alternatives illustrated in the embodiment of FIG. 8C, the quantification scale may be expressed as follows:

TABLE 1-1

Very strong (absolute preference) for Aⱼ
Strong preference for Aⱼ
Strict (definite) preference for Aⱼ
Weak preference for Aⱼ
Indifference between Aⱼ and Aₖ
Weak preference for Aₖ
Strict (definite) preference for Aₖ
Strong preference for Aₖ
Very strong (absolute) preference for Aₖ

By selecting a specific checkbox from checkbox set 870, the evaluation assessor chooses the statement that best expresses his relative preference for the pair of alternatives under consideration, i.e., alternative j compared to alternative k. The statement can be interpreted as a ratio. In alternative embodiments, the evaluation scale could be more refined by increasing the number of checkboxes in checkbox 870. The extremes could remain the same, however.

If, for example, the statement selected by an evaluation assessor while comparing alternative i and alternative j is denoted by matrix element aᵢⱼ, then the information relevant to the preferences expressed by that evaluation assessor can be expressed by matrix elements a₁₂, a₁₃ and a₂₃. According to the notation adopted herein, element a₂₁ equals the opposite of a₁₂ in the scale provided in Table 1-1. A pairwise comparison (PWC) matrix A is defined in this case as follows:

$$A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] \qquad ( 1 )$$

By definition, the diagonal elements are neutral. Depending on the specific pairwise comparison method employed, aₙ=1 or 0. With a₁₂, a₁₃, a₂₃, there is enough information to construct the PWC matrix A.

In an alternative embodiment, a scale similar with the one in Table 1-2 may be used to quantify the opinions of the evaluation assessors:

TABLE 1-2

| | Original AHP, |
|---|---|
| Comparative preferential judgement of | estimated ratio of |
| Aⱼ with respect to Aₖ | subjective values |
| Very strong (absolute preference) for Aⱼ | 9 |
| Strong preference for Aⱼ | 7 |
| Strict (definite) preference for Aⱼ | 5 |
| Weak preference for Aⱼ | 3 |
| Indifference between Aⱼ and Aₖ | 1 |
| Weak preference for Aₖ | 1/3 |
| Strict (definite) preference for Aₖ | 1/5 |
| Strong preference for Aₖ | 1/7 |
| Very strong (absolute) preference for Aₖ | 1/9 |

Consistent with the symmetric definition provided above for the elements of matrix

A, if Ajk=9 then Akj=1/9 and Ajj=1.

The relative preferences of the evaluation assessors are identified by determining the eigenvalues and eigenvectors of matrix A. Generally, an (n)x(n) square matrix has a set of n eigenvalues, and for each eigenvalue, a corresponding eigenvector. The multiplication of a matrix with one of its eigenvectors results in the same vector with all of its elements scaled by a factor.

Denoting eigenvalues by λ and eigenvectors by x, this property may be expressed as,

Ax=λx (A1)

The (right-hand) eigenvector corresponding to the largest eigenvalue represents the relative ranking of the alternatives with respect to the criteria under consideration.

To better understand the operation of evaluation module 720 in conjunction with the pairwise comparison evaluation method, consider the following example. Suppose there are three cars: C (1), V (2) and F (3). For the criterion “comfort of seats,” Ms. Y expresses a slight preference for C compared to V, an absolute preference for C as compared to F and a ‘normal’ preference for V as compared to F. The PWC matrix can be constructed now with the corresponding entries from Table 1-2:

$$A = [ \begin{matrix}1 & 3 & 9 \\ 1 \text{/} 3 & 1 & 5 \\ 1 \text{/} 9 & 1 \text{/} 5 & 1\end{matrix} ]$$

The eigenvector corresponding to the largest eigenvalue of matrix A is (normalized to a sum of 1):

$$\underline{w} = [ \begin{matrix}0.676 \\ 0.264 \\ 0.0586\end{matrix} ]$$

This means that alternative 1 (C) scores highest with 68%, alternative 2 (V) scored 26% and alternative 3 (F) scored 6% for the “comfort of seats” criterion.

The consistency of an evaluation assessor with respect to criteria can be expressed as a Consistency Index (CI) provided by,

$$CI = \frac{{λ}_{max} - n}{n - 1} \qquad ( 2 )$$

where n represents the number of alternatives and λₘₐₓ represents the highest eigenvalue of matrix A. Generally, lower values for the consistency index indicate better consistency for the evaluation assessor's opinions.

For the above example, the largest eigenvalue of matrix A and the consistency index CI of the evaluation assessor are,

λₘₐₓ3.04, and

CI=(3.04-3)/2=0.02.

In alternative embodiments, evaluation module 820 employs different pairwise comparison evaluation methods to quantify the opinions expressed by evaluation assessors. According to an alternative embodiment, a pairwise comparison evaluation method denoted as “Multiplicative Analytical Hierarchical Process” (“Multiplicative AHP”) defines scale values as the ratios of the relative preferences. According to yet another embodiment, a pairwise comparison evaluation method denoted as “Additive Analytical Hierarchical Process” (“Additive AHP”) defines scale values as the logarithms of the relative preferences expressed by the evaluation assessor. Examples of scale values according to each of these alternative embodiments are provided in Table 1-3:

TABLE 1-3

| | | | Multi- |
|---|---|---|---|
| | Original | Additive | plicative |
| | AHP, | AHP, | AHP, |
| | estimated | difference | estimated |
| | ratio of | of grades | ratio of |
| Comparative preferential judgement | subjective | δ_{jkd=}log₂ | subjective |
| of Aⱼ with respect to Aₖ | values | (r_{jkd}) | values r_{jkd} |
| Very strong (absolute preference) | 9 | 8 | 256 |
| for Aⱼ | | | |
| Strong preference for Aⱼ | 7 | 6 | 64 |
| Strict (definite) preference | 5 | 4 | 16 |
| for Aⱼ | | | |
| Weak preference for Aⱼ | 3 | 2 | 4 |
| Indifference between Aⱼ | 1 | 0 | 1 |
| and Aₖ | | | |
| Weak preference for Aₖ | 1/3 | −2 | 1/4 |
| Strict (definite) preference | 1/5 | −4 | 1/16 |
| for Aₖ | | | |
| Strong preference for Aₖ | 1/7 | −6 | 1/64 |
| Very strong (absolute) preference | 1/9 | −8 | 1/256 |
| for Aₖ | | | |

For a single evaluation assessor, a vector W with components wj indicating the relative preferences of the evaluation assessor with respect to a particular criteria is expressed as follows:

$${w}_{j} = \frac{1}{n} {\sum }_{k = 1}^{n} {δ}_{jk} j = 1 , 2 , … n , \qquad ( 3 )$$

where n represents the number of alternatives, δⱼₖ is the element at the j^{th} row and in the k^{th} column of the PWC matrix A expressed in additive AHP scores and wⱼ is the indicator for relative preference for alternative j.

According to equation (3), wⱼ is the arithmetic mean of the j^{th} row in the PWC matrix A.

Returning to the example above, the PWC matrix A is adapted to the scale values of the Additive AHP pairwise comparison evaluation method. The statements of Ms. Y remain the same. Matrix A can now be written as,

$${A}_{add} = [ \begin{matrix}0 & 2 & 8 \\ - 2 & 0 & 4 \\ - 8 & - 4 & 0\end{matrix} ]$$

In a more general situation, for an arbitrary number G of evaluation assessors, the elements of the preference vector W with respect to a particular criteria may be expressed as,

$${w}_{j} = \frac{1}{nG} {\sum }_{k = 1}^{n} {\sum }_{d = 1}^{G} {δ}_{jkd} j = 1 , 2 , … n \qquad ( 4 )$$

where δ_{jkd} indicates the statement made by evaluation assessor d regarding alternative j compared to alternative k.

Evaluation module 820 seeks to determine vector w=(w₁ w₂. . . Wₙ)^{T} of relative preferences for which the opinions of the evaluation assessors are covered best. Equation (4) allows evaluation module 820 to determine vector W, but with one significant condition: all the entries of the PWC matrix A must be available. Alternatively stated, the evaluation assessors must have expressed preferences with respect to each pair of alternatives. To use equation (4), evaluation module 820 must receive a complete set of responses from evaluation assessor module 810.

According to an embodiment of the present invention, however, having a complete set of responses from the evaluation assessors may not be necessary. In a particular embodiment, evaluation of alternatives with an incomplete set of responses may be achieved by performing a “least squares” minimization of the distance between the difference of wⱼ and wₖ with respect to the corresponding statement of the evaluation assessors, δ_{jkd}. This statement may be expressed as follows:

$${\sum }_{{k = 1}_{k \neq j}}^{n} {\sum }_{d ∈ {D}_{jk}} {( {δ}_{jkd} - ( {w}_{j} - {w}_{k} ) )}^{2} j = 1 , 2 , … n \qquad ( 5 )$$

The minimum of this expression may be identified by determining its first derivative with respect to wⱼ and setting it equal to zero:

$${\sum }_{{k = 1}_{k \neq j}}^{n} {\sum }_{d ∈ {D}_{jk}} ( {δ}_{jkd} - {w}_{j} + {w}_{k} ) = 0 j = 1 , 2 , … n \qquad ( 6 )$$

This equation may be rewritten as follows:

$$\begin{matrix}{\sum }_{{k = 1}_{k \neq j}}^{n} {\sum }_{d ∈ {D}_{jk}} {δ}_{jkd} & = & {w}_{j} {\sum }_{{k = 1}_{k \neq j}}^{n} {N}_{jk} & - & {\sum }_{{k = 1}_{k \neq j}}^{n} {N}_{jk} {w}_{k} \\ ( a ) & = & ( b ) & - & ( c )\end{matrix} \\ j = 1 , 2 , … n \qquad ( 7 )$$

These expressions have n unknown variables, w₁, w₂, . . . , wₙ. Nⱼₖ denotes the number of evaluation assessors who expressed their opinions with respect to that particular comparison of alternatives and is denoted as “cardinality.” Evaluation module 820 must isolate vector W from the other data in a manner that facilitates computation on a computer.

According to an aspect of the present invention, vector W representing the opinions of evaluation assessors with respect to alternatives under consideration may be expressed in a format particularly adequate for evaluation on a computer.

According to an aspect of the invention, the members of equation (7) can be expressed as follows:

$$( a ) = [ {\sum }_{d ∈ {D}_{jk}} {PWC}_{d} ] * [ \begin{matrix}1 \\ 1 \\ . \\ 1\end{matrix} ] and \qquad ( 8 )$$

(b)−(c)=[DiagonSom(N)−N]*w, (9)

where matrix N denotes the cardinality matrix associated with the PWC matrices. Cell (j,k) of N expresses the cardinality of the comparison of alternative j with k. Matrix DiagonSom(N) contains the row totals of matrix N.

According to an aspect of the invention, vector W can be expressed as follows:

$$\underline{w} = {[ DiagonSom ( N ) - N ]}^{- 1} * [ {\sum }_{d ∈ {D}_{jk}} {PWC}_{d} ] * [ \begin{matrix}1 \\ 1 \\ . \\ 1\end{matrix} ] \qquad ( 10 )$$

An embodiment of the present invention provides a method for collaborative decision making based on the identification of certain individuals involved. The method includes receiving in a computer system coupled to a data network a set of alternative choices. The computer system also receives a set of criteria by which the set of alternative choices may be evaluated. A first set of individuals sends to the computer system via the data network a set of weights. Each weight indicates importance of a respective criterion from the set of criteria. The computer system further receives via the data network a set of evaluations sent by a second set of individuals. Each evaluation corresponds to possible attributes of a respective criterion. Based on the set of evaluations, the set of weights and the identification of the individuals, a relative analysis of the alternative choices is provided. The weights indicate importance of the respective criteria from a set of criteria. The assessments include evaluations corresponding to possible attributes of the respective criteria. In a particular embodiment, identifiers are used to distinguish evaluators (assessors), and the assessments of assessors are treated differently depending on the identifier. For example, based on the identifier, the system may know that the individual is a specialist. Accordingly, the assessment of a specialist in a field corresponding to the respective criterion receives a stronger treatment. In a particular embodiment, at least a possible identifier is an identifier of a financial specialist, and the assessment of a financial criterion by a specialist receives a stronger treatment depending on the identifier of the specialist being the identifier of a financial specialist.

The project manager or the evaluation manager may assign different degrees of importance to specific evaluation assessors. For example, if certain evaluation assessors possess high expertise in an area pertinent to the evaluation under consideration, the opinions of these evaluation assessors may receive a higher weight than the opinions of the other evaluation assessors. One advantage provided by an embodiment of the invention is that key specialists or experts in various fields may participate in the group decision making process without regard of their location, and their inputs may receive appropriate weight. In another embodiment of the invention, the degree of expertise of certain users in a specific area may be used to either make such users the exclusive evaluators for certain criteria, weights or alternatives, or to disqualify them from such evaluations.

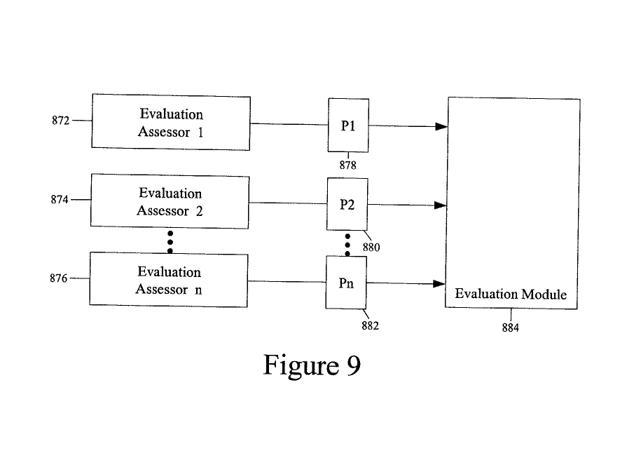

FIG. 9 shows a schematic illustration of weighting of evaluation assessments according to an embodiment of the present invention. In the embodiment of FIG. 9, the opinions of the evaluation assessors are weighted by a set of weights before being processed by evaluation module 884: the opinions of evaluation assessor 1 (872) are weighted by weight P1 (878), the opinions of evaluation assessor 2 (874) are weighted by weight P2 (880) and the opinions of evaluation assessor n (876) are weighted by weight Pn (882).

Accounting for weights P1, P2 . . . and Pn, expression (a) becomes:

$$( a ) = [ {\sum }_{d ∈ {D}_{jk}} {p}_{d} {PWC}_{d} ] * [ \begin{matrix}1 \\ 1 \\ . \\ 1\end{matrix} ] \qquad ( 11 )$$

Defining a new weighted cardinality matrix N′ corresponding to the PWC matrices, whose elements N′ⱼₖ are expressed as

$${N}_{jk}^{′} = {\sum }_{d ∈ {D}_{jk}} {p}_{d} , \qquad ( 12 )$$

vector W can be expressed as follows:

$$\underline{w} = {( [ DiagonSom ( {N}^{′} ) - {N}^{′} ] )}^{- 1} * [ {\sum }_{d ∈ {D}_{jk}} {p}_{d} {PWC}_{d} ] * [ \begin{matrix}1 \\ 1 \\ . \\ 1\end{matrix} ] . \qquad ( 13 )$$

The expression for vector W in equation (13) quantifies the combined opinion of a group of evaluation assessors regarding a set of alternatives with respect to a particular criterion by minimizing the average distances in the grade space for all assessors who evaluated the respective criteria, and taking into account the fact that distances for evaluation assessors whose opinions are more important must be minimized correspondingly more. A general discussion of pairwise comparison may be found in “MCDA via ratio and difference judgement”, by Lootsma, F. A., Multicriteria Decision Analysis via Ratio and Difference Judgment, Kluwer Academic Publishers, Dordrecht 1999, p. 53-64 and 139-146, which is hereby incorporated herein by reference in its entirety.

The Multiplicative AHP and Additive AHP pairwise comparison methods previously discussed do not provide adequate consistency index figures that may be used to estimate the consistency of the opinions of evaluation assessors.

An aspect of the present invention provides a consistency index figure that evaluates the consistency of opinions expressed by evaluators in pairwise comparison evaluations. The consistency index may be used to evaluate the degree to which the opinions provided by various evaluation assessors agree. Conceptually, the consistency index is similar to the standard deviation measure employed in the field of mathematical statistics. The consistency index provides a tool for evaluating whether a specific grade assigned to an alternative indicates that evaluation assessors tend to agree with that grade, or whether that grade is a weighted average of opinions that vary widely. In the latter case, for example, the project manager may choose to contact individual evaluation assessors to further explore the reasons for their disagreements in their opinions.

Equation (5) may be expressed as

$$\sum {\{ [ \begin{matrix}{δ}_{11} & & & {δ}_{1 n} \\ & {δ}_{22} & & ⋯ \\ & & ⋯ & ⋯ \\ - {δ}_{1 n} & ⋯ & ⋯ & {δ}_{nn}\end{matrix} ] - [ \begin{matrix}{w}_{1} - {w}_{1} & {w}_{1} - {w}_{2} & ⋯ & {w}_{1} - {w}_{n} \\ {w}_{2} - {w}_{1} & {w}_{2} - {w}_{2} & ⋯ & {w}_{2} - {w}_{n} \\ ⋯ & ⋯ & ⋯ & ⋯ \\ {w}_{n} - {w}_{1} & ⋯ & ⋯ & {w}_{n} - {w}_{n}\end{matrix} ] \}}^{2} = \sum {\{ PWC + [ \begin{matrix}1 \\ ⋯ \\ 1\end{matrix} ] * {\underline{w}}^{T} - \underline{w} * [ 1 … 1 ] \}}^{2} = \sum D \qquad ( 14 )$$

The notation (matrix)² denotes that the elements of the matrix are individually squared. For example:

$${[ \begin{matrix}2 & 3 \\ 4 & 8\end{matrix} ]}^{2} = [ \begin{matrix}4 & 9 \\ 16 & 64\end{matrix} ] \qquad ( 15 )$$

In equation (14), D indicates the individual distance in the grade space of the opinions of an evaluation assessor from the average grade vector W.

The elements of vectors W indicate relative preferences of evaluation assessors for alternatives under consideration. In a particular embodiment of the present invention, evaluation module 820 converts entries of vectors W from an additive domain corresponding with equation (14) into a multiplicative domain. One advantage associated with this conversion is that it facilitates determination of relative preference percentages for the alternatives evaluated by evaluation assessors. To convert to the multiplicative grade domain and obtain percentage components w corresponding to additive vectors W, evaluation module 826 may employ the following formula:

$${w}_{j}^{′} = \frac{{2}^{{w}_{j}}}{{\sum }_{j = 1}^{n} {2}^{{w}_{j}}} \qquad 16 )$$

Summation over all relative grades w′ evaluates to 1, corresponding to 100%. To obtain percentage figures for individual components w, evaluation module 820 multiplies components w by 100:

w′ⱼ(%)=w′ⱼ*100. (17)

The expression for the grade vectors provided in equation (10), (13) and (16) may be easy to implement on a computer and may be evaluated with a high degree of accuracy. According to an aspect of the present invention, the results of a group decision making process may be more reliable, and consequently, more persuasive when evaluation module 820 employs the methods of equations (10), (13) and (16) to evaluate the opinions expressed by evaluation assessors.

Another advantage of an aspect of the present invention is that in the pairwise comparison method expressed by equation (14), the elements of pairwise comparison matrix PWC (which in a particular embodiment is constructed in accordance with the process described in connection with equation (1)) do not need to be fully defined. More specifically, some of the elements may be missing, possibly because a particular evaluation assessor fails to express one or more opinions with respect to one or more pairs of alternatives, or possibly because evaluation module 820 denies a particular alternative assessor access to evaluation of one or more pairs of alternatives. In such a case, the entries corresponding to the missing evaluations are left blank in the respective pairwise comparison matrix PWC, and evaluation module 820 proceeds with pairwise evaluation processing as described herein.

According to an aspect of the invention, a measure of the consistency of the responses of an evaluation assessor according to the pairwise comparison evaluation method expressed in equation (14) is the Consistency Index provided by,

CI=squareroot(D/(n²−n))/8 (18)

where D represents the individual distance in the grade space of the opinions of an evaluation assessor from the average grade vector W provided by equation 14. In one embodiment of the invention, the Consistency Index of equation (18) ranges from 0 to 1 and lower values for the Consistency Index indicate better consistency for the evaluation assessor.

An aspect of the present invention provides significant flexibility in evaluation of the alternatives under consideration by different evaluation methods. According to an aspect of the present invention, evaluation module 820 evaluates opinions expressed by evaluation assessors with respect to alternatives using any of the following evaluation methods in various embodiments: (1) multiple choice; (2) direct entry; (3) pairwise comparison; (4) multiple choice combined with pairwise comparison; (5) direct entry combined with pairwise comparison; (6) multiple choice combined with direct entry; and (7) multiple choice combined with direct entry and pairwise comparison. In alternative embodiments, additional evaluation methods may exist. Consequently, additional combinations of methods of evaluation of alternatives may also exist.

Evaluation of alternatives using the direct entry or multiple choice methods produces absolute results in the grade domain because, as described above in conjunction with particular alternative embodiments of the present invention, evaluation module 820 utilizes predefined conversion mappings between the evaluation assessor opinion space and the grade space. A criteria manager specifies actual grades or conversion methods that map entries in the opinion space (whether entered as multiple choice entries or direct entries) to specific grades. In contrast, evaluation of alternatives according to pairwise comparison produces relative results in the grade domain because the relative preferences of evaluation assessors are determined relative to each other. Specifically, evaluation in accordance with equations (3), (4), (10), or (13) provide vectors W whose components indicate grades corresponding to relative preferences of evaluation assessors for the alternatives under consideration. Consequently, evaluation module 820 may not be able to directly combine evaluation of alternatives using direct entry or multiple choice with evaluation employing pairwise comparison because the absolute grade domains associated with the first two methods may not be meaningfully related to the relative grade domain of pairwise comparison.

According to an aspect of the present invention, however, evaluation module 820 may combine evaluation of alternatives using direct entry or multiple choice with evaluation employing pairwise comparison by translating the relative grade space associated with pairwise comparison into an absolute grade space. According to an aspect of the present invention, evaluation module 820 may combine evaluation of alternatives using direct entry or multiple choice with evaluation employing pairwise comparison by determining a “shift constant.” This shift constant translates the relative grade space corresponding to pairwise comparison into the absolute grade space of direct entry or multiple choice to provide a consistent grade coordinate space in which the different evaluation methods may be directly compared.

If the shift constant is denoted as 0, the components of vector W indicating the relative preferences of an evaluation assessor may be translated into the absolute grade coordinate system of direct entry or multiple choice according to the following expression:

gᵢ=wⱼ+θj=1,2. . . n (19)

According to the present invention, shift constant θ may be determined in multiple ways. In one embodiment of the present invention, evaluation module 826 asks an evaluation assessor to indicate how close to ideal is one of the alternatives provided for evaluation according to pairwise comparison. The distance between the relative grade determined by evaluation module 826 and the ideal alternative provides a shift constant θ that may be used to translate the other relative grades into an absolute grade domain. In an alternative embodiment of the present invention, evaluation module 826 presents an evaluation assessor with parallel evaluations of the same alternatives and criteria using both pairwise comparison, and direct entry or multiple choice. The opinions of the evaluation assessor are then used to determine shift constant θ since the absolute grades for those particular alternatives and criteria are determined by evaluation according to direct entry or multiple choice. In yet another embodiment of the present invention, evaluation module 820 includes an ideal choice among the alternatives presented to an evaluation assessor, and subsequently shifts the relative grades such that the relative grade corresponding to the ideal choice translates into the maximum possible grade. The corresponding difference correlates with shift constant θ. In other alternative embodiments, evaluation module 820 may employ additional methods to determine shift constant θ.

An embodiment of the present invention provides a method for collaborative decision making. The method includes receiving in a computer system a set of alternative choices and a set of criteria by which the set of alternative choices may be evaluated. The computer system also receives via a data network coupled to the computer system a set of weights sent to the computer system by a first set of individuals via the computer network. Each weight indicates importance of a respective criterion from set of criteria. The computer system further receives via the data network a set of evaluations sent to the computer system by a second set of individuals. Each evaluation corresponds to possible attributes of the respective criteria. The second set of individuals provide evaluations using any of the following combinations of evaluation methods: pairwise comparison combined with direct entry; pairwise comparison combined with multiple choice; and pairwise comparison combined with direct entry and with multiple choice. A relative analysis of the alternative choices is then provided based on the set of evaluations and the set of weights. In an alternative embodiment, the first set of individuals evaluate the weights using pairwise comparison combined with direct entry.

In one embodiment, in addition to determining grades for the criteria under consideration, evaluation module 820 also determines certain properties pertaining to the evaluations provided by users (e.g., the consistency of the responses by different users). For example, evaluation module 820 may determine a measure of the consistency of the evaluations of criterion 1 to evaluate the degree of consensus exhibited by the opinions expressed by various users.

Before, during or after evaluation module 820 completes evaluation of alternatives with respect to criteria, weighting module 830 evaluates the importance of various criteria under consideration by determining weights for such criteria. The results produced by evaluation module 1 (822), evaluation module 2 (824) and evaluation module n (826) are eventually processed using information provided by weighting module 830. Weighting module 830 comprises a number n of weight modules, including weight module 1 (832), weight module 2 (834) and weight module n (836). Each of these weight modules receives information from weighting assessor module 840.

Weighting assessor module 840 stores information regarding weighting assessors who assign weights to criteria and allows them to record their opinions. In the embodiment of FIG. 8A, weighting assessor module 840 stores information regarding an arbitrary number of weighting assessors denoted by “q,” including weighting assessor 1 (842), weighting assessor 2 (844) and weighting assessor q (846). Each weight software module comprised in weighting module 830 receives inputs from some or all of the weighting assessors identified in weighting assessor module 840 and processes this information to derive a group opinion for the relative importance of the corresponding criterion. For example, in the embodiment of FIG. 8A, weight module 1 (832) receives from weighting assessor module 840 information regarding the opinions of each weighting assessor, including weighting assessor 1 (842), weighting assessor 2 (844) and weighting assessor q (846).

According to an aspect of the present invention, weighting module 830 evaluates opinions expressed by weighting assessors with respect to criteria using any of the following evaluation methods: (1) direct entry; (2) pairwise comparison; or (3) direct entry combined with pairwise comparison. In alternative embodiments, additional evaluation methods may exist. Consequently, additional combinations of methods of evaluation of alternatives may also exist.

The discussion of direct entry and pairwise comparison presented above in connection with evaluation of alternatives by criterion module 802, evaluation assessor module 810 and evaluation module 820 also may apply, according to various embodiments of the invention, with appropriate modifications, to evaluation of weights by weighting module 830 and weighting assessor module 840. For example, references to evaluation module 820 should be to weighting module 830, references to evaluation module 1 (822) should be to weigh module 1 (832), references to evaluation module 2 (824) should be to weigh module 2 (834), references to evaluation module n (826) should be to weigh module n (834), references to evaluation assessor module 810 should be to weighting assessor module 840, references to evaluation assessor 1 (812) should be to weighting assessor 1 (842), references to evaluation assessor 2 (814) should be to weighting assessor 2 (844) and references to evaluation assessor q (816) should be to weighting assessor q (846). Additionally, while in one embodiment evaluation of alternatives may only take place with respect to end criteria, weights may be assigned to all criteria in alternative embodiments, including end criteria and node criteria.

In one embodiment of the invention, grades assigned to weights by weighting module 830 as a result of pairwise comparison represent numerical percentages. To convert the components of grade vector W to percentage values, weighting module 830 may employ methods expressed in formulas (16) and (17).

Each of the weight modules comprised in weighting module 830 produces a group-averaged weight corresponding to each criterion under consideration. These weights are then employed by grading module 850 according to predefined methods to determine group-averaged final grades for the corresponding root criterion. For example, weight module 1 (832) produces a weight that modifies the group-averaged final grades represented by the appropriate components of vectors Wd produced by evaluation module 1 (822).

The group-averaged final vectors produced by evaluation module 820 and the group-averaged weights produced by weighting module 830 are then further processed by grading module 850. Grading module 850 determines and stores a group-averaged final grade for the root criterion associated with the criteria tree under consideration.

According to an embodiment of the invention, intermediate grades for node criteria and a group averaged final grade for the root criterion may be determined based on grades assigned to one or more dependent end criteria using a Simple Multiple Attribute Rating Technique (“SMART”). In one embodiment, SMART provides a method for grading of criteria comprising at least one dependent sub-criteria using a weighted sum of the grades of the sub-criteria. In an embodiment, grades for root and node criteria stored in grading module 850 are determined by adding the grades for the dependent sub-criteria provided by evaluation module 820, wherein the grades are weighted by corresponding grades provided by weighted module 830.

Assume, for example, that criterion C is a node criterion comprising end criteria A and B. Further, assume that, with respect to a particular alternative X, evaluation module 820 assigns a grade GA to end criterion A and a grade GB to end criterion B. Further, assume that weighting module 830 assigns a weight WA to end criterion A and a weight WB to end criterion B. According to an embodiment of the invention, the corresponding grade GX stored in grading module 850 for criterion X is,

Gₓ=W_{A}*G_{A}+W_{B}*G_{B}.

In a particular embodiment, each criterion corresponds to a grade vector, wherein each element of the vector represents a grade of a particular alternative with respect to that criterion. Consequently, in that embodiment, the grade GX determined in the example above would constitute an elements of a grade vector corresponding to node criterion C.

Intermediate grades for node criteria may be determined analogously with the process illustrated in the example above, and the intermediate weights may in turn be employed recursively to determine grades for parent criteria with respect to a particular alternative. Upon determination of grades for all leaf and node criteria, a final group averaged grade may be determined for the root criterion.

The operations described above illustrate how system 800 determines a group averaged final grade for a set of alternatives with respect to a particular root criterion. Either system 800 or analogous systems determine group averaged grades for other root criteria with respect to the set of alternatives employing analogous processes. Group averaged grades for various root criteria are input into a comparison module which ranks the alternatives with respect to the criteria (block 858). The embodiment of FIG. 8A then either automatically ranks the alternatives based on evaluation of the n criteria to produce a final result (block 858) or provides the information stored in grading module 850 to a human individual acting as project manager for further analysis. In an embodiment of the present invention, the ranking provided by the decision processing system may be used to select the top alternatives and use them to conduct another full or partial decision evaluation process. For example, the top two alternatives may be resubmitted to the evaluation assessors and weight assessors for another evaluation round.

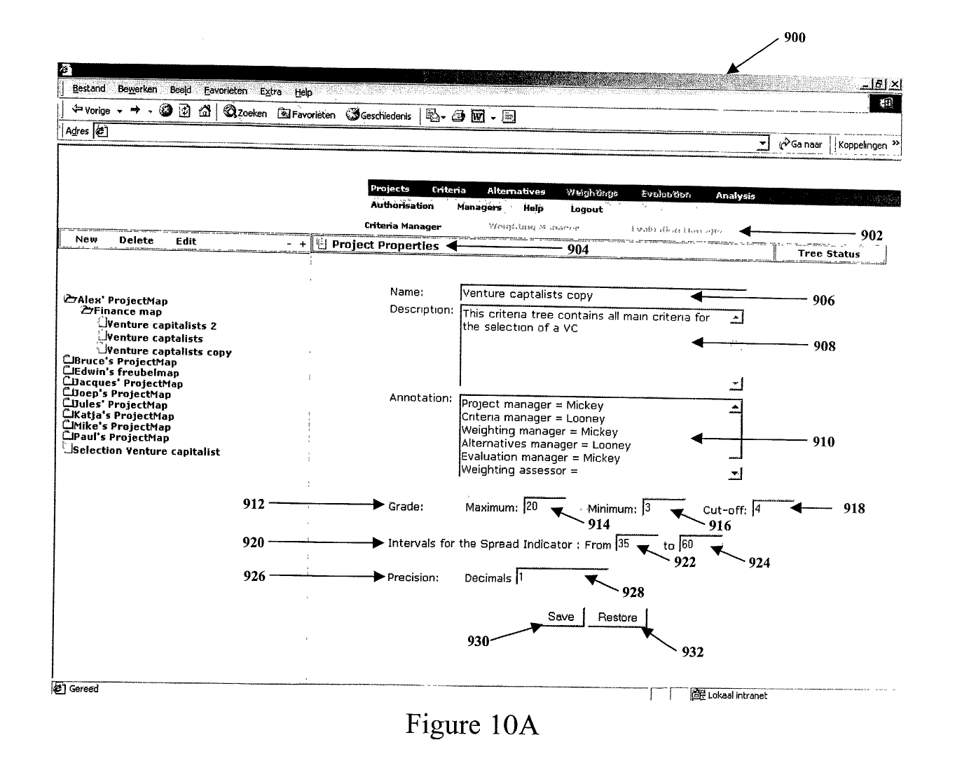

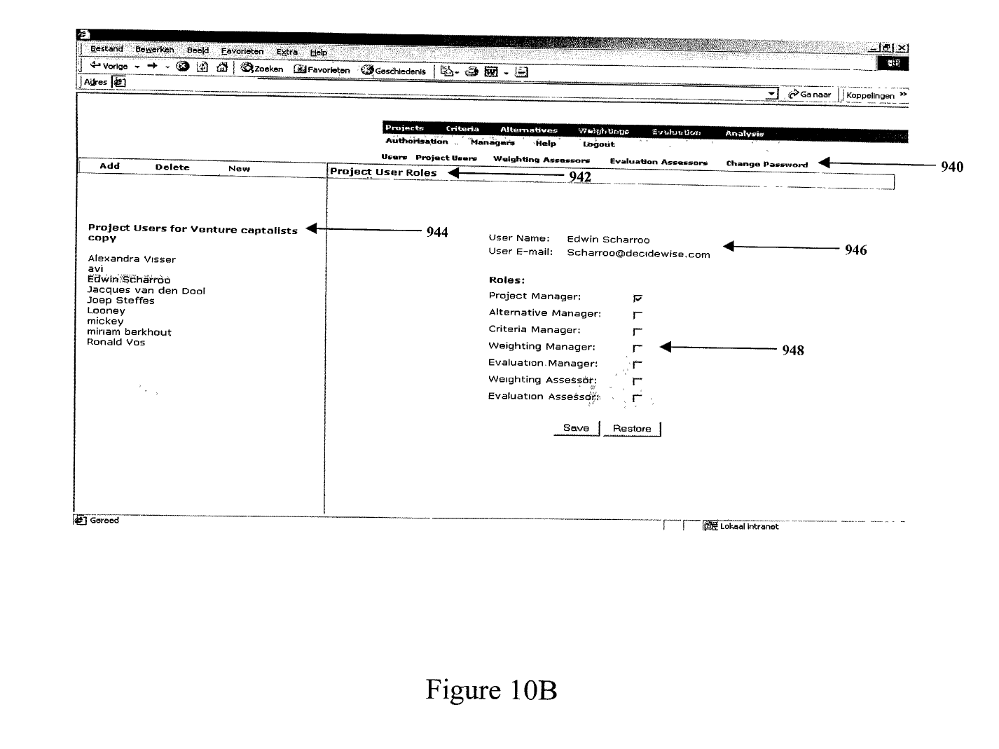

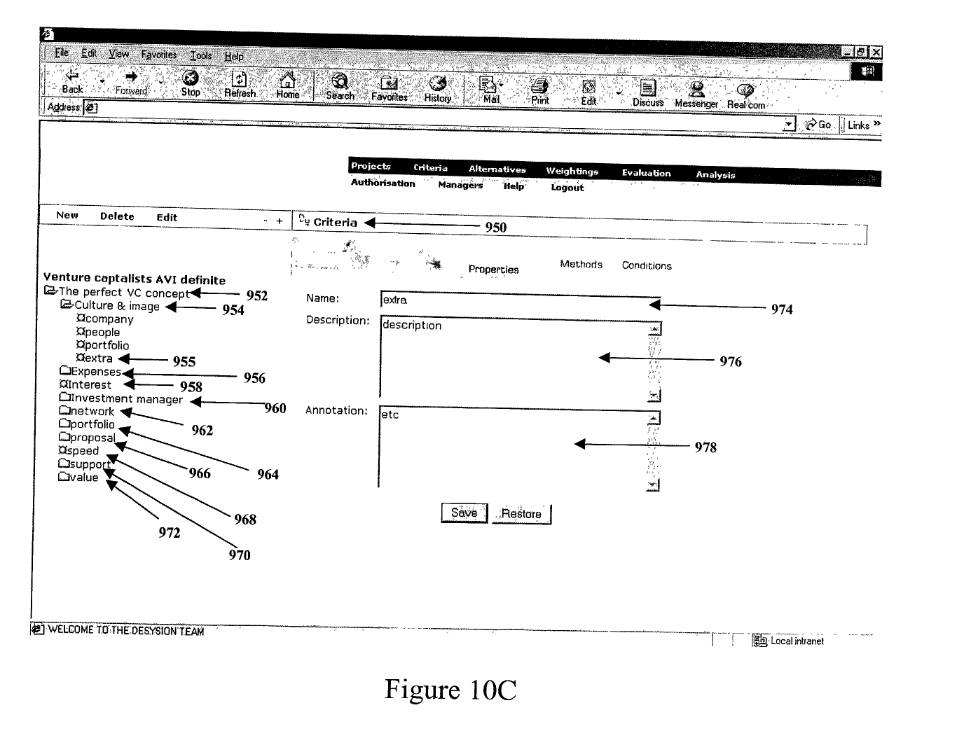

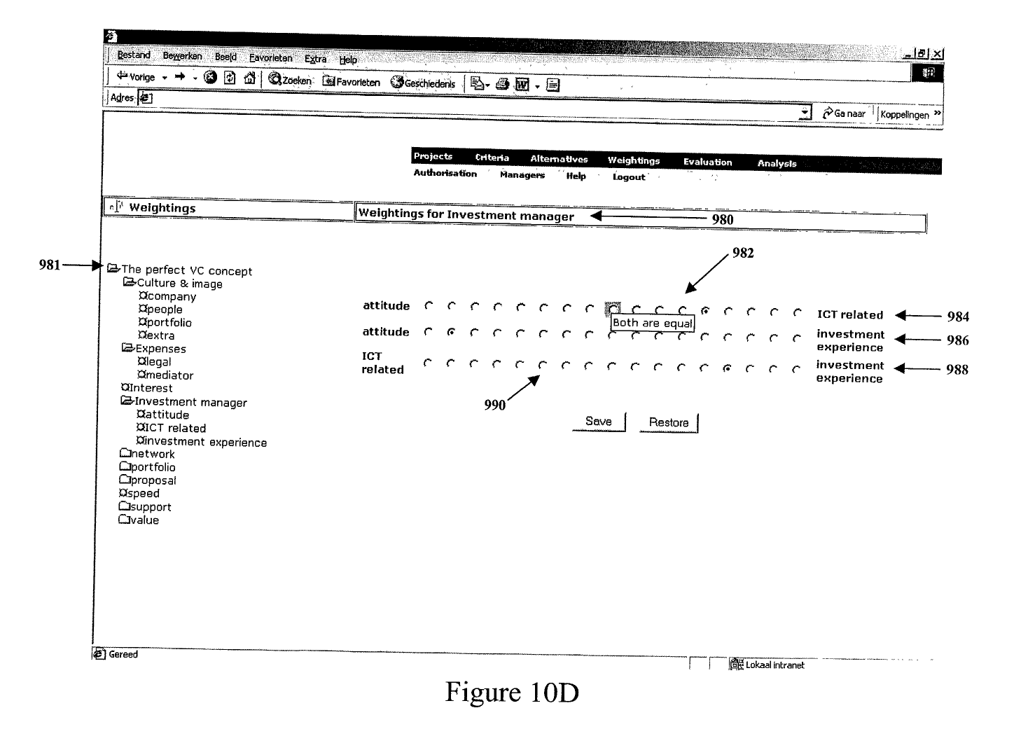

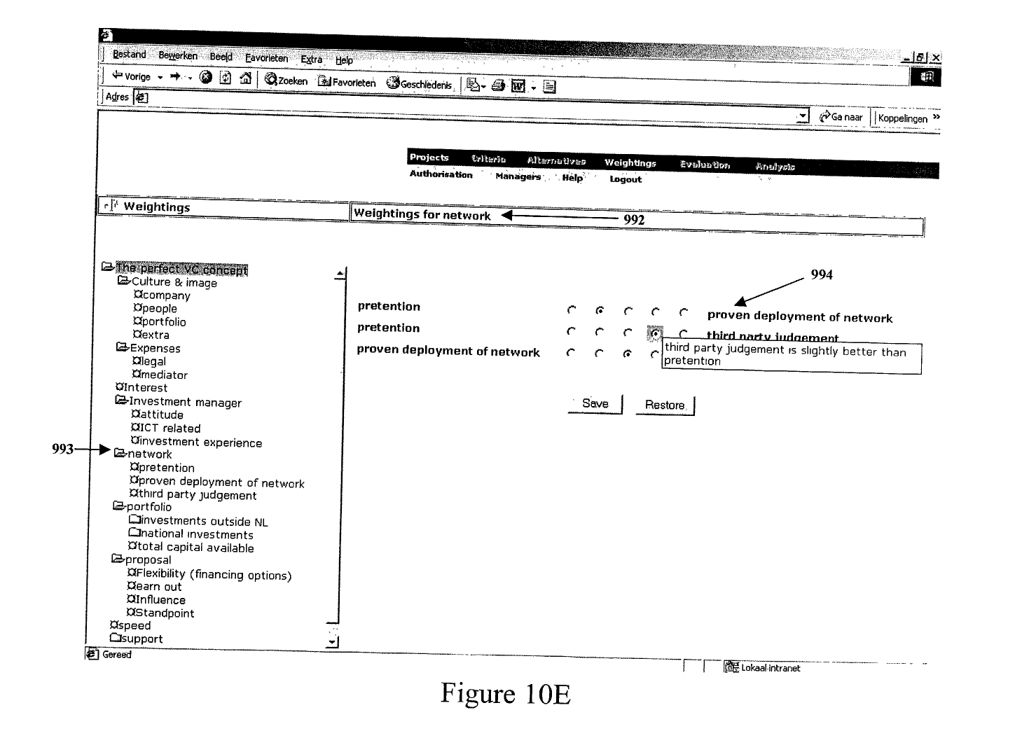

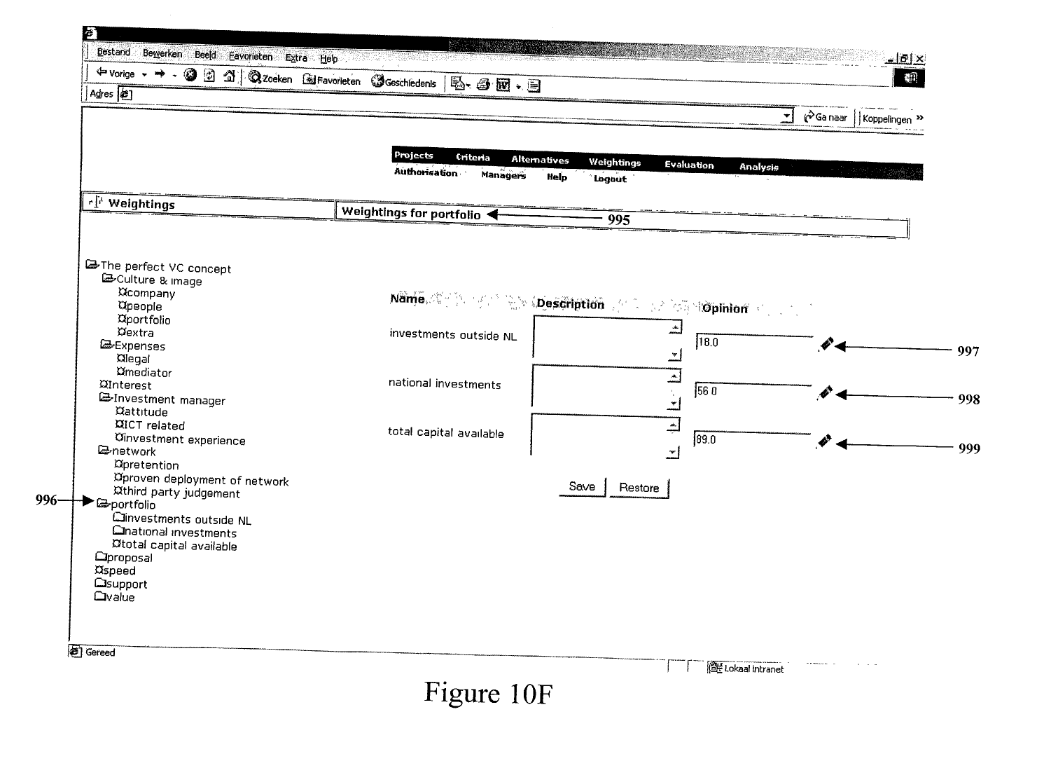

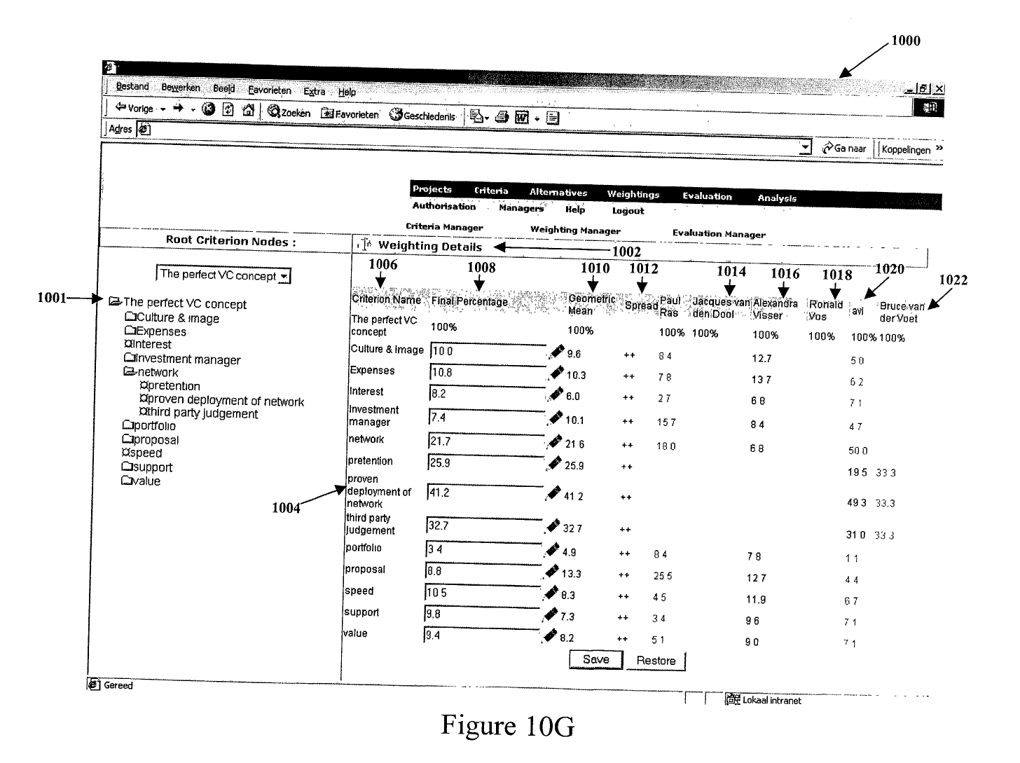

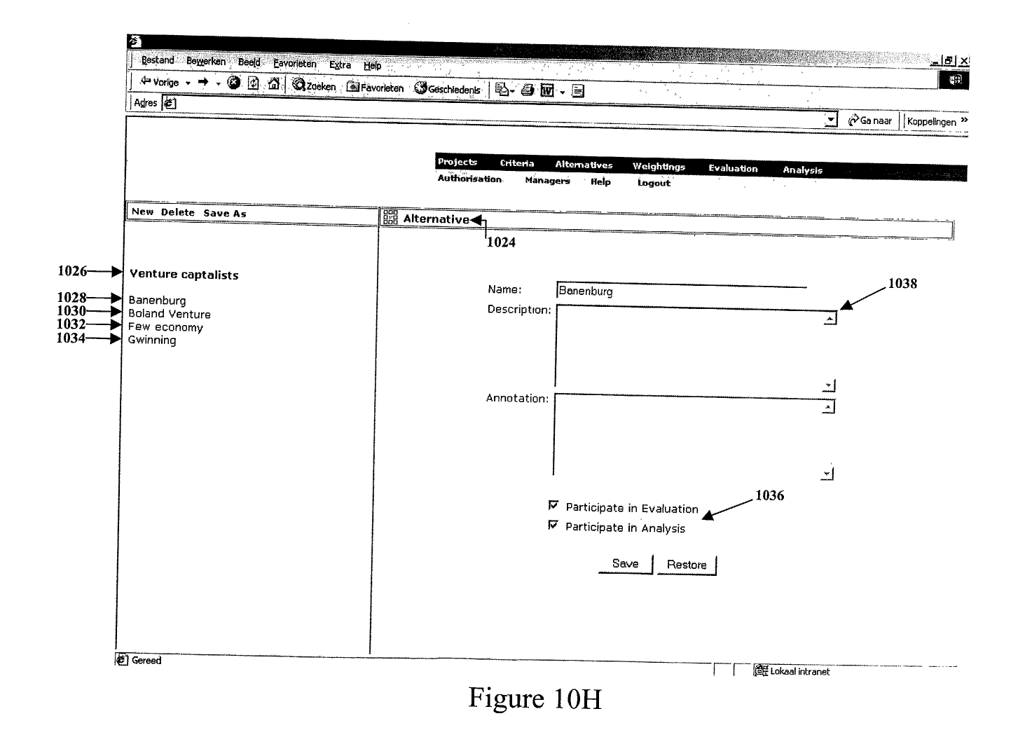

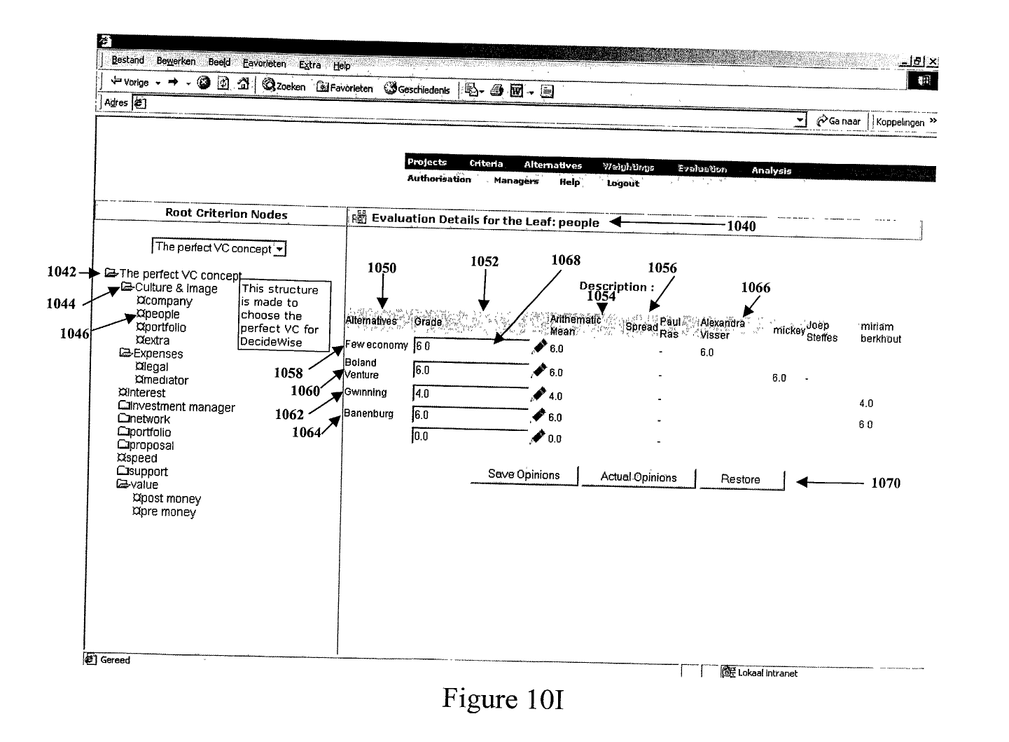

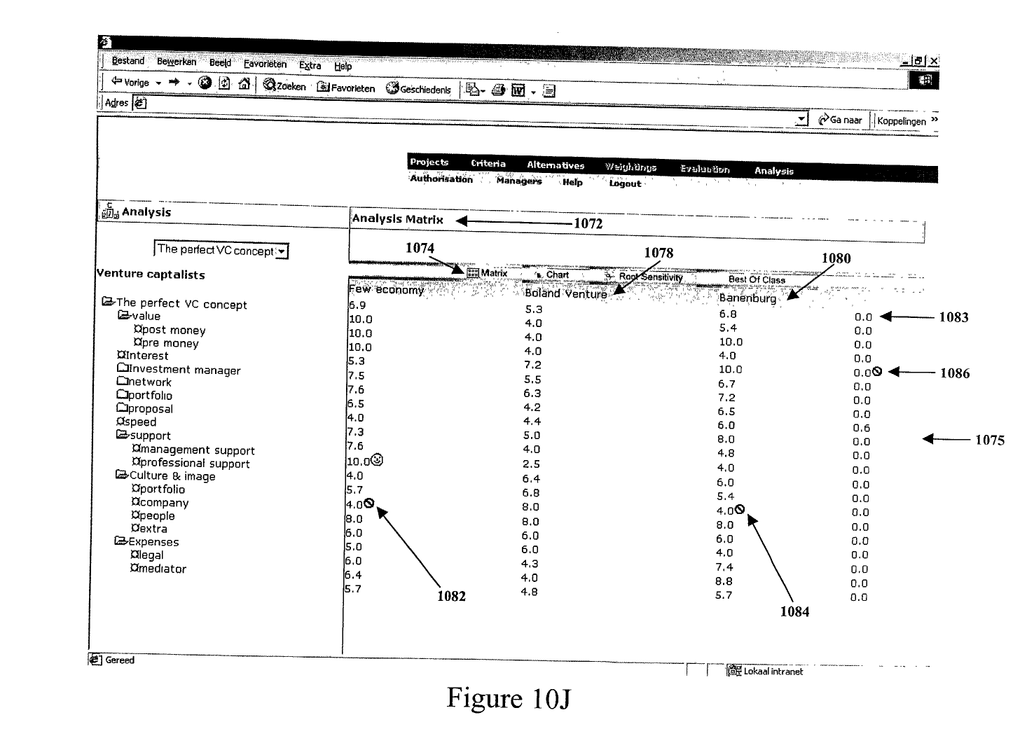

FIG. 10A shows a screen example from a user interface in a distributed decision processing system, according to an embodiment of this invention. FIG. 10A shows Graphical User Interface 900. Graphical User Interface 900 comprises authorization field 902. Authorization field 902 identifies the active user. In the embodiment of FIG. 10A authorization field 902 shows three possible user access levels: criteria manager, weighting manager and evaluation manager. Graphical User Interface 900 also shows function field 904. Function field 904 identifies the current function in progress. Graphical User Interface 900 further comprises name field 906, description field 908, and annotation field 910. In the embodiment of FIG. bOA, name field 906 identifies the project currently in progress. Description field 908 and annotation field 910 provide additional information regarding the project currently in progress. Grade interval field 912 provides information regarding the range of grades that can be assigned in the evaluation process. Grade interval field 912 comprises maximum grade field 914, minimum grade field 916 and cut-off grade field 918. Maximum grade field 914 identifies the maximum of the range of grades that can be assigned. Minimum grade field 916 identifies the minimum of the range of grades that can be assigned by evaluation assessors.

Cut-off grade field 918 identifies the cut-off grade below which any grades assigned are automatically scored with the same grade as the minimum grade. For example in the embodiment of FIG. 10A, cut-off grade field 918 shows a cut-off grade of 4. Minimum grade field 916 shows a minimum grade of 3. Consequently any grades allocated by evaluation assessors between 3 and 4 would automatically be scaled down to 3. In an embodiment of the invention, when the direct entry method of comparison is employed, raw scores that fall between the values shown in minimum grade field 916 and maximum grade field 914 are mapped via a value function to a grade range spanning from the grade shown in cut-off grade field 918 to the grade shown in maximum grade field 914.

Spread interval field 920 identifies an interval for the spread indicator of the evaluations in progress. In an embodiment of the present invention, spread measures the variation in grades assigned by evaluation assessors. For example in a particular embodiment, the spread is determined by dividing the standard deviation over the group of assessors by the average. In an alternative embodiment, the spread indicates the difference between the highest grade and lowest grade assigned by evaluation assessors for a particular alternative.

Spread interval field 920 comprises minimum spread field 922 and maximum spread field 924. Minimum spread field 922 and maximum spread field 924 identify spread thresholds which define intervals of relative consistency for analysis of grades. In an embodiment of the invention, spreads that fall below the value shown in minimum spread field 922 are graphically marked as “−” to indicate that they exhibit a high consistency. Similarly, spreads that fall between the value shown in minimum spread field 922 and the value shown in maximum spread field 924 are graphically marked as “+” to indicate that they exhibit acceptable consistency. Finally, spreads that fall above the value shown in maximum spread field 924 are graphically marked as “++” to indicate that they exhibit low consistency.

Precision definition field 926 identifies the precision with which numerical evaluations will take place in the system. Precision definition field 926 comprises decimal selection field 928. Decimal selection field 928 shows the number of decimals that will be used in numerical evaluations in the present embodiment. For example in the embodiment of FIG. 10A decimal selection field 928 shows a number of 1, which indicates that numerical evaluations will be performed with a precision of one decimal. Save button 930 allows the criteria manager to save the information entered into the embodiment of FIG. 10A. Restore button 932 allows the criteria manager to restore the values of the fields of the embodiment of FIG. 10A to default values or to preexisting values.

FIG. 10B shows another screen example from a user interface in a distributive decision processing system, according to an embodiment of the invention. The embodiment of FIG. 10B comprises authorization field 940, function field 942, user identification field 944, active user field 946 and roles field 948. Authorization field 940 identifies the users who are authorized to view and alter the information presented on the current screen. Function field 942 identifies the current function being performed on the current screen. For example, in the embodiment of FIG. 10B, function field 942 shows that the current screen identifies roles for project users. User identification field 944 identifies users with roles in the current project. Active user field 946 identifies information relating to a particular user. Roles field 948 provides a list of possible roles in the system. In a particular embodiment of FIG. 10B, roles field 948 shows that the particular user identified in active user field 946 has a function of project manager.

FIG. 10C shows another screen example from a user interface in a distributed decision processing system, according to an embodiment of the invention: Function field 950 identifies the function being currently performed of the current screen. For example, in the embodiment of FIG. 10C, function field 950 shows that the current screen provides information or allows modification of criteria. Criteria field 952 identifies a set of criteria trees for the project in progress. In the embodiment of FIG. 10C, criteria field 952 identifies trees comprising root and leaf criteria. The criteria trees of criteria field 952 comprise a number of root criteria, including culture and image criterion 954, expenses criterion 956, investment manager criterion 960, network criterion 962, portfolio criterion 964, proposal criterion 966, support criterion 970 and value criterion 972. The criteria trees of criteria field 952 also comprise a number of end criteria, also know as leaf criteria, including interest criterion 958 and speed criterion 968. Criteria field 952 also shows four leaf criteria depending on culture and image criteria 954, i.e., company, people, portfolio and extra criterion 955.

In alternative embodiments of the present invention, partial or complete criteria trees may be stored or retrieved to enable reuse of existing criteria structures. Among other advantages, this permits reuse of criteria trees that are developed with input from multiple users, thereby providing cost and time savings in future projects where criteria trees may be reused if appropriate for problems under consideration. In alternative embodiments, weights associated with criteria in criteria trees may also be stored or reused, thereby providing additional cost and time savings. Further, in yet other embodiments, either complete or partial sets of alternatives comprising criteria trees and weights may be stored or reused if appropriate. An embodiment of the present invention provides mechanisms for categorization, indexing, search and retrieval of criteria, weights and alternatives to enable efficient storage and retrieval.

In other embodiments, additional information may be stored to improve future group decision-making processes. In one embodiment, for example, information regarding the efficiency, accuracy, promptitude and other characteristics of various participating users may be stored to facilitate optimal selection of participants in future group decisions. In another embodiment, information regarding the alternatives, criteria, weights or individual opinions that led to either good or bad decisions may be stored to assist in improved future definition of decision making projects.

Name field 974 identifies a specific criterion currently under consideration. Description field 976 and annotation field 978 provide additional information regarding the criterion identified in name field 974. For example, in the embodiment of FIG. 10C, extra criterion 955 is currently under consideration, as indicated in name field 974. Description field 976 and annotation field 978 provide information relating to extra criterion 955.

FIG. 10D shows yet another example from a user interface in a distributed decision processing system, according to an embodiment of the invention. The embodiment of FIG. 10D comprises function field 980, which identifies the function being currently performed. In the embodiment of FIG. 10D, function field 980 indicates that weightings for a particular criterion are being currently evaluated. Active criteria field 981 identifies criteria trees currently under consideration. In the embodiment of FIG. 10D, criterion field 981 shows that a particular criterion, investment manager, is under consideration. Pairwise comparison evaluation field 982 shows that the weighting method currently employed is pairwise comparison. Criteria field 981 shows that there are three criteria currently under consideration, including criterion 1 (984), criterion 2 (986), and criterion 3 (988). In the embodiment of FIG. 10D, the three criteria under consideration are ICT related, investment experience, and attitude.

FIG. 10E shows yet another screen example from a user interface in a distributed decision processing system, according to an embodiment of the invention. FIG. 10E shows function field 992, which identifies the function being currently performed. Criteria field 993 identifies a specific criterion currently under consideration. Pairwise comparison evaluation field 994 shows that the weighting method currently being employed is pairwise comparison.

FIG. 10F shows yet another screen example from a user interface in a distributed decision processing system, according to an embodiment of the invention. FIG. 10F shows function field 995, which identifies the function currently being performed. Criteria field 996 identifies a specific criterion currently under consideration. Weight field 1 (997), weight field 2 (998), and weight field 3 (999) identify specific weights assigned by weight assessors in the system for different criteria.

FIG. 10G shows yet another screen example from a user interface in a distributed decision processing system, according to an embodiment of the invention. Graphical User Interface 1000 comprises criteria trees 1001 and summary matrix 1004. Criteria trees 1001 identify the criteria currently under consideration. Summary matrix 1004 provides a summary of results of the evaluation process currently in progress. Function field 1002 identifies the function being currently performed. In the embodiment of FIG. 10G, function field 1002 shows that the current screen provides weighting details. The weighting manager may use graphical user interface 1000 to review the weights assigned by individual weighting assessors and the group average weights and spreads.

Summary matrix 1004 comprises criteria fields 1006, final weight fields 1008, geometric mean fields 1010 and spread fields 1012. Criteria fields 1006 identify the criteria currently under consideration. Final weight fields 1008 identify the final weights that weight assessors have assigned to each individual criteria under consideration. Geometric mean fields 1010 identify the geometric mean that was computed based on the individual weight assessments made by the weight assessors in the system for each criteria. Spread fields 1012 identify the consistency of responses from different weight assessors for each particular criterion. User 1 fields 1014, user 2 fields 1016, user 3 fields 1018, user 4 fields 1020, and user 5 fields 1022 identify individual weight grades assigned By by particular users. In the embodiment of FIG. 10G, for example, user Alexandra Visser assigned a weight of 12.7 to criterion culture and image.

In an embodiment of the invention, a cut-off value for the consistency index identifying the consistency of the evaluations provided by evaluation assessors or criteria assessors represents a maximum desirable value for the consistency index. Consistency index values that are higher than the cut-off value signify a low consistency of the responses provided by evaluators, which may trigger a flag in the graphical display of results. For example, in the display screen of FIG. 10G, a consistency index value above the cut-off value may result in highlighting of fields associated with the corresponding criterion.

FIG. 10H shows yet another screen example from a user interface in a distributed decision processing system, according to an embodiment of the invention. In the embodiment of FIG. 10H, function field 1024 identifies the function being currently performed. Alternative fields 1026 identify a set of alternatives currently being evaluated. Alternative fields 1026 comprise alternative 1 field 1028, alternative 2 field 1030, alternative 3 field 1032 and alternative 4 field 1034. In the embodiment of FIG. 10H, alternative 1 field 1028 identifies Banenburg as the alternative currently under consideration. Data fields 1038 provide information regarding particular alternatives under consideration. In the embodiment of FIG. 10H, data fields 1038 provide information regarding Banenburg as the alternative currently under consideration. Alternative status fields 1036 provide status information regarding the alternative currently under consideration.

FIG. 10I shows yet another screen example from a user interface in a distributed decision processing system, according to an embodiment of the invention. In the embodiment of FIG. 10I, function field 1040 provides information regarding the function currently being performed. Criteria tree 1042 identifies the criteria being evaluated. Criteria tree 1042 comprises root criterion 1044 and leaf criterion 1046. Alternative fields 1050 identify the alternatives under consideration. Grade fields 1052 identify the grades assigned to the alternatives by evaluation assessors in the system. In one embodiment, grades shown in the screen example of FIG. 10I comprise consensus grades and consensus weighting factors that are passed on by an evaluation manager and a weighting manager. Arithmetic mean fields 1054 identify the arithmetic means for the grades assigned by different evaluators to each alternative under consideration. Spread fields 1056 identify the spreads of the grades assigned by evaluation assessors for each alternative under consideration.

In the embodiment of FIG. 10I, there are four alternatives under consideration, including Few economy 1058, Boland Venture 1060, Gwinning 1062 and Banenburg 1064. Names used herein are fictional. Evaluation assessor fields 1066 identify a particular evaluation assessor and display the grades assigned by that particular evaluation assessor to the alternatives under consideration. For example, in the embodiment of FIG. 10I, evaluation assessor fields 1066 identify Alexandra Visser as an evaluation assessor who has assigned a grade of 6 to alternative Few economy. Grade field 1068 shows the average grade for alternative Few economy, which is 6. Buttons 1070 provide different options and functionality with respect to the information currently displayed.

FIG. 10J shows yet another screen example from a user interface in a distributed decision processing system, according to an embodiment of the invention. The project manager may use the screen of FIG. 10J to review the group average grades assigned to the alternatives for each criteria, at each level in the criteria trees. In an embodiment of the invention, these average grades include information regarding grades and weights provided by the evaluation manager and, respectively, weighting manager.

Function field 1072 shows the function currently in progress. Options field 1074 identifies the functionality available in the analysis of the information currently displayed. In the embodiment of FIG. 10I, for example, options field 1074 shows that a matrix evaluation, a chart evaluation, a root sensitivity evaluation, or a best of class evaluation may be performed with respect to the information currently displayed. Matrix 1075 provides summary information regarding the analysis of criteria performed. Matrix 1075 comprises alternative 1 field 1076, alternative 2 field 1078 and alternative 3 field 1080. In the embodiment of FIG. 10J, alternative 1 field 1076 identifies Few economy, alternative 2 field 1078 identifies Boland Venture and alternative 3 field 1080 identifies Banenburg. In one embodiment, final grade field 1083 identifies the final group-averaged grades assigned by evaluation assessors to each alternative under consideration. Stop condition 1 (82), stop condition 2 (1084) and stop condition 3(1086) show stop conditions which were triggered during the evaluation process. Stop conditions occur when evaluations by one or more evaluation assessors are outside a range defined as acceptable. In a particular embodiment of the present invention, a stop condition permanently eliminates the respective alternative from farther consideration.

In the embodiment of FIG. 10J, final grade field 1083 shows the final grades assigned to the three alternatives under consideration. Few economy received a final grade of 6.9, Boland Venture received a final grade of 5.3, and Banenburg received a final grade of 6.8. A strict ranking of the three alternatives identifies alternative number 1, Few Economy, as the top choice, followed by Banenburg and Boland. However, stop condition 1 (1082) eliminates Few economy as an alternative under consideration. Stop condition 2 (1084) eliminates Banenburg as a viable alternative. Consequently, in a particular embodiment of the present invention, Few economy and Banenburg are eliminated as potential choices and Boland Venture becomes the top choice.

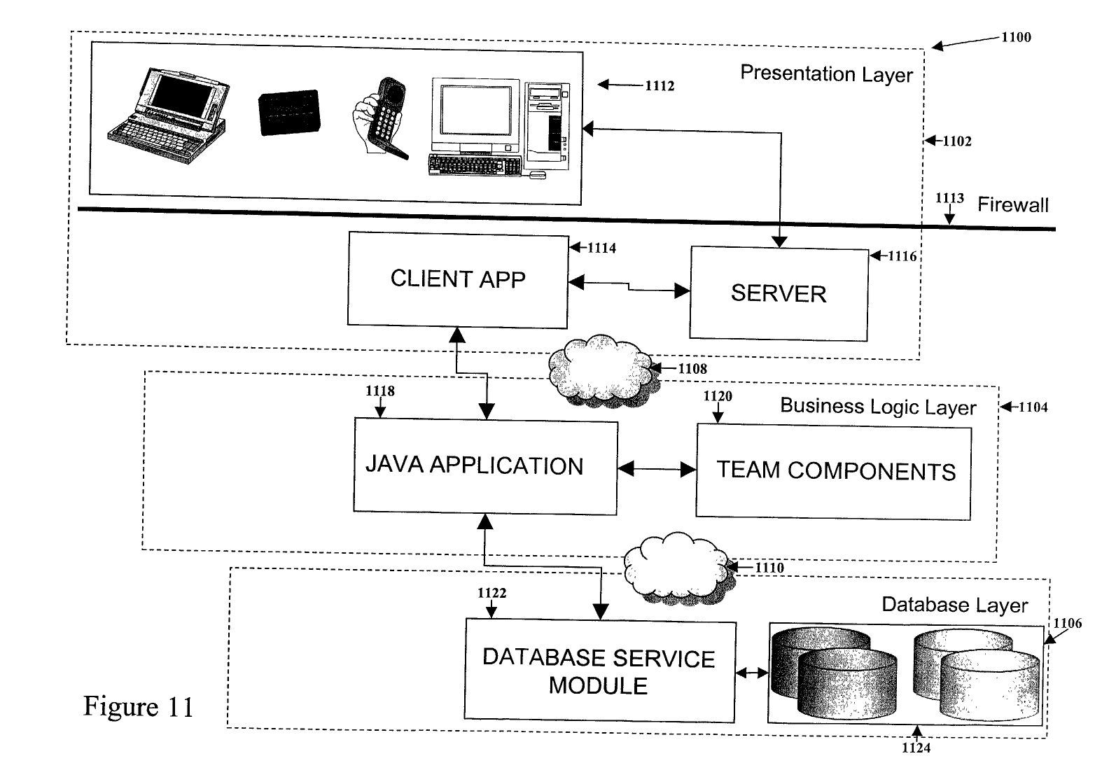

FIG. 11 illustrates various elements of a distributed decision processing system, according to an embodiment of the present invention. FIG. 11 provides an overview of functional layers that contain business logic and manage and facilitate communication between components of an embodiment of the present invention. System 1100 comprises presentation layer 1102, business logic layer 1104 and database layer 1106. Business logic layer 1104 is coupled to both presentation layer 1102 and database layer 1106 and facilitates communication between presentation layer 1102 and database layer 1106. In a particular embodiment, communications including definition, transmission, validation, or interpretation of data between business logic layer 1104 and presentation layer 1102 take place according to the Extensible Markup Language (XML) protocol. In an alternative embodiment, communications including definition, transmission, validation, or interpretation of data between business logic layer 1104 and database layer 1106 take place according to the XML protocol.

Presentation layer 1102 provides a front-end interface between system 1100 and a human user. Presentation layer 1102 comprises client device 1112, firewall 1113, client application 1114 and server 1116. Client device 1112 is coupled to server 1116, which is coupled to client application 1114. In a particular embodiment of the present invention, firewall 1113 is disposed between client device 1112 and server 1116 to guide communications and provide data security or other services.

In alternative embodiments, data transmissions within presentation layer 1102 are transmitted according to the HyperText Transfer Protocol (http), Secure Sockets Layer (SSL or https) protocol, HyperText Markup Language (html), or include computer instructions in the Java programming language, and may take place via the World Wide Web. In other alternative embodiments, communications within presentation layer 1102 comprise information encoded as ActiveServerPages or as JavaScript. In alternative embodiments, communications between client server 1112 and server 1116 may be through a wired connection, over a wireless link, or may employ a combination of wired and wireless transmissions. In a particular embodiment, server 1116 runs Internet Information Server software.

In alternative embodiments, client device 1112 comprises one or more of the following: mobile computer, laptop, personal digital assistant (PDA), cellular telephone, desktop computer, server computer, or mainframe computer. An advantage of various embodiments of the invention is that the broad availability of such devices, together with the flexibility that they provide, permit human users to manage and participate in individual or group decision making processes essentially without regard of geographical or temporal limitations.

Business logic layer 1104 comprises Java application module 1118 and team component modules 1120. in one embodiment, business logic layer 1104 comprises a modular architecture which facilitates addition, removal or replacement of various modules comprised therein. Functional collocation of Java application module 1118 and team component modules 1120 within business logic layer 1104 provides a number of advantages, including scalability and enhanced security. Java application module 1118 communicates with team component modules 1120 and acts as a gateway towards presentation layer 1102 and database layer 1106, facilitating, among others, updating of a database comprised within database layer 1106 and data communications according to the Structured Query Language (SQL) protocol.

Database layer 1106 comprises database service module 1122 and database 1124. Database service module 1122 communicates with both business logic layer 1104 and database 1124. Database service module 1122 relates data queries from Java application module 1118 addressed to database 1124 and manages information retrieval from database 1124. In a particular embodiment of the present invention, communication between Java application module 1118 and database service module 1122 employs the XML communication protocol. In a preferred embodiment, data communications between database service module 1122 and database 1124 are encoded according to the Open DataBase Connectivity protocol (ODBC). Since ODBC provides device-independent connectivity as long as compliance with the ODBC protocol is maintained, this embodiment provides significant flexibility in selection of database 1124. In alternative embodiments, database 1124 may comprise database software such as relational databases or other database types.

In operation, client device 1112 communicates with server 1116 and interacts with client application 1114. Client device 1112 transmits commands that are executed or processed by client application 1114. Depending on the nature of the commands, client application 1114 transmits some or all of the commands originated by client device 1112 to Java application module 1118, or initiates separate commands. Java application module 1118 relates some or all of these commands to team component modules 1120 or database service module 1122, or initiates new commands. In a particular embodiment, Java application module 1118 queries database 1124 through database service module 1122 in response to a request from client device 1112.

Database service module 1122 processes the query received from Java application module 1122, extracts appropriate information from database 1124 and transmits that information to Java application module 1118 and client application 1114. Client application 1114 then processes the data retrieved from database 1124 and provides an appropriate response to the command initiated by client device 1112.

For example, in a particular embodiment of the present invention, an evaluation assessor may utilize a laptop as client device 1112 to evaluate a set of alternatives with respect to a particular criteria. The evaluation assessor connects with a computer server acting as a website host (server 1116) and uses a web browser like Microsoft Explorer or Netscape Communicator to log into client application 1114. Client application 1114 allows the evaluation assessor to view information relevant to the alternatives and criteria under consideration by retrieving this information from database 1124 with the assistance of Java application module 1118 and database service module 1122.

The multiple layer architecture of the embodiment shown in FIG. 11 provides significant flexibility in interconnecting various users who are participating in a decision making process or in scaling the capabilities of the system according to various embodiments of the present invention. For example, in various embodiments of the invention, users participating in the decision process may be able to communicate with other users or with a central module in real time via voice or data transmissions, including email or data messaging. According to a particular embodiment, the decision processing system may employ push technology to, for example, efficiently and appropriately contact particular users, possibly by email, to solicit specific information or inputs.

In other embodiments, the decision processing system may communicate with other systems to augment its data processing capabilities. For example, in an embodiment of the invention, a decision processing system may employ an external computational engine (e.g., software data processing systems like Excel, Matlab or Mathematica) to perform specialized data processing functions. To facilitate communication with other data processing systems, the decision processing system according to an embodiment may transmit and receive data according to the XML protocol. In other embodiments, the data processing system comprises various import-export modules that facilitate interaction and cooperation with external data processing systems including electronic hardware and software. In a particular embodiment, the data processing system comprises a module that allows interaction with the Netmeeting software application running either locally, remotely, or in a distributed computational system.

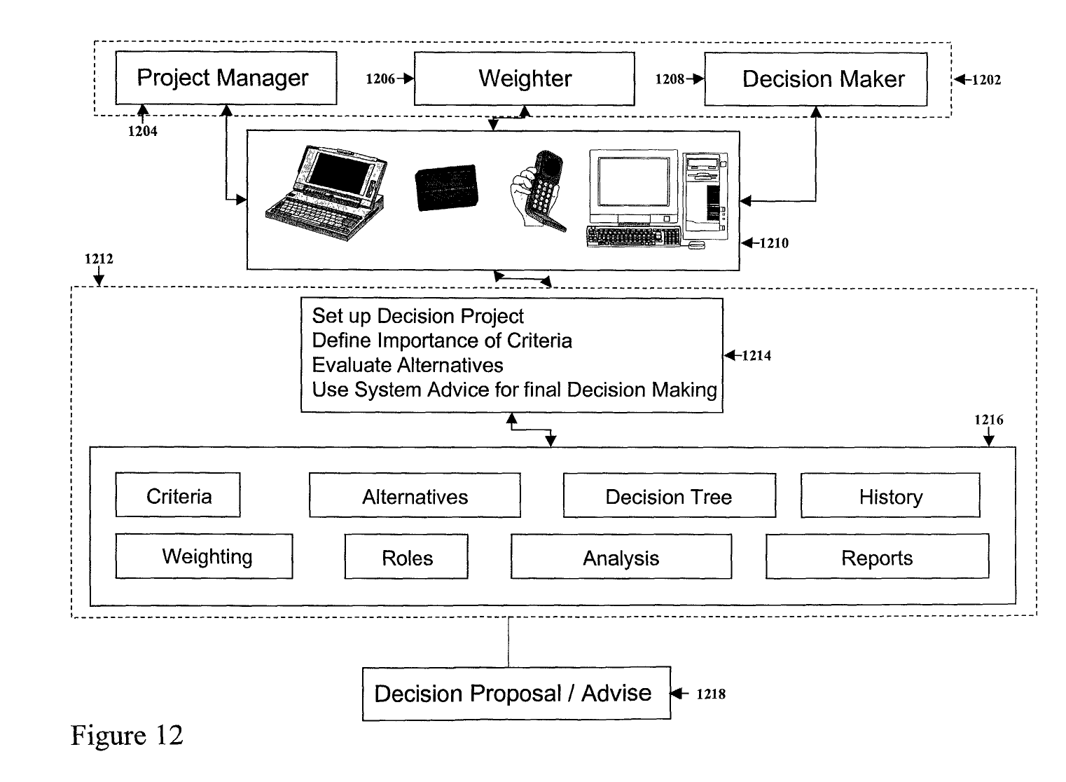

FIG. 12 illustrates interconnection of various elements of a distributed decision processing system according to an embodiment of the present invention. FIG. 12 shows how participants in a group decision making process interact with components of a system according to an embodiment of the present invention. In the embodiment of FIG. 12, users 1202 interact with access layer 1210 and data processing system 1212 to arrive at a group decision according to an embodiment of the present invention.

Access layer 1210 is coupled to data processing system 1212. In alternative embodiments, access layer 1210 communicates with data processing system 1212 via a wired connection or through a wireless link. Access layer 1210 facilitates communications between users 1202 and data processing system 1212.

According to an embodiment of the invention, users 1202 comprise project manager 1204, weighter 1206 and decision maker 1208. In alternative embodiments, access layer 1202 comprises one or more client devices, including mobile computers, laptops, personal digital assistants (PDAs), cellular telephones, desktop computers, server computers or mainframe computers. Users 1202 utilize access layer 1202 to communicate with data processing system 1212.

In a particular embodiment, users 1202 include project manager 1204, weighter 1206 and decision maker 1208. In alternative embodiments, weighter 1206 includes one or more weighting assessors or weighting managers and decision maker 1208 includes one or more evaluation assessors or evaluation managers. In alternative embodiments, users 1202 comprise additional users.

Data processing system 1212 comprises modules 1214 and data structures 1216. Modules 1214 perform various functions in the evaluation process and communicate with data structures 1216 to store or retrieve data. In an embodiment of the invention, modules 1214 comprise software modules performing one or more of the following functions: set up project, define importance of criteria, evaluate alternatives and suggest a final solution to the problem under consideration. Data structures 1216 comprise various data structures that store information relevant to the decision making process, including data structures for criteria, alternatives, decision trees, evaluation history, weighting, roles, analysis and reports. In an embodiment of the invention, data processing system 1212 provides a group-averaged decision 1218.

In operation, users 1202 employ access layer 1202 to communicate with modules 1214 and data structures 1216 to enter information relevant to group decision making, including evaluation of alternatives and criteria under consideration. Data processing system 1214 utilizes the information provided by users 1202 and proposes a solution to the problem under consideration.

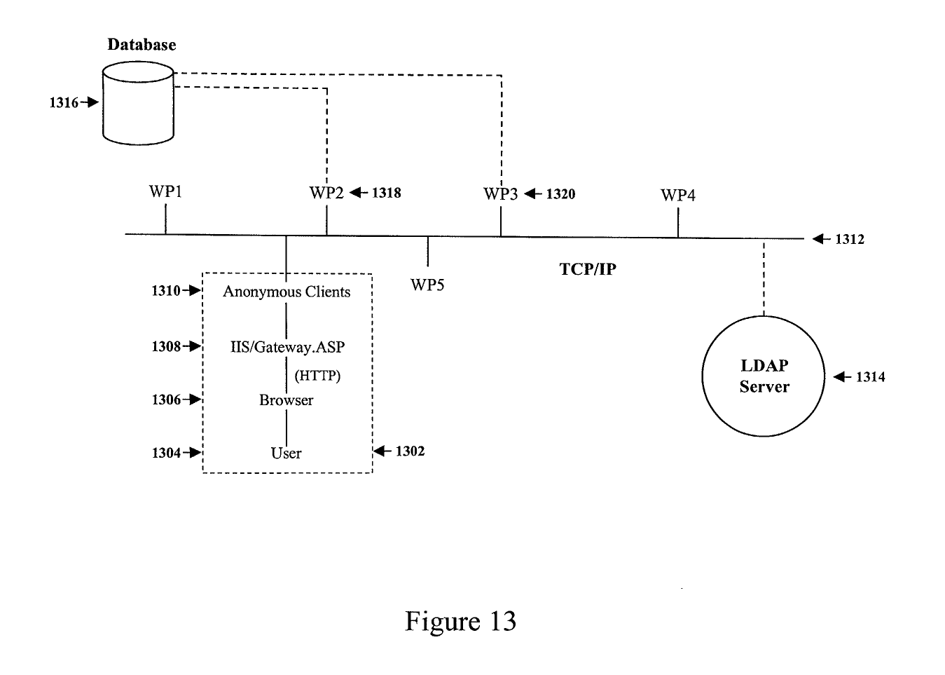

FIG. 13 illustrates another interconnection of various elements of a distributed decision processing system, according to an embodiment of the present invention. In the embodiment of FIG. 13, client system 1302 communicates with server 1314 and database 1316 via communication bus 1312 to assist a group of remote users in a collaborative decision making process.

Data processing system 1300 comprises client system 1302, which is coupled to server 1314 and database 1316 via communication bus 1312. Client system 1302 comprises a layered functional architecture including anonymous clients 1310, gateway 1308, browser 1306 and user 1304. Anonymous clients 1310 are coupled to communication bus 1312 and gateway 1308. Gateway 1308 is coupled to browser 1306 and facilitates communications between browser 1306 and anonymous clients 1310. In a particular embodiment, gateway 1308 communicates with browser 1306 via HyperText Markup Language (html). In an alternative embodiment, gateway 1308 comprises an Internet Information Server.

In an alternative embodiment of the present invention, browser 1306 provides a graphical interface for user 1304 to data processing system 1300. In alternative embodiments, user 1304 may access data processing system 1300 through non-visual methods, including, for example, by a telephone system coupled to a voice recognition module comprised in data processing system 1300.

Client system 1302 is coupled to server 1314 via communication bus 1312. In an embodiment of the present invention, communication bus 1312 comprises an enterprise integration bus (EIB). In a particular embodiment, EIB architecture is used to handle requests and commands submitted by users and formatted as XML documents. In an embodiment, the enterprise integration bus comprises a database service module, a Java service module and a client module. In one embodiment, the EIB architecture employs a TCP/IP data connection protocol. Various worker processes including worker process WP2 (1318) and worker process WP3 (1320) are connected to communication bus 1312 and process XML requests transmitted via communication bus 1312.

Server 1314 is connected to communication bus 1312 and coordinates communications and data processing in the data processing system according to an embodiment of the present invention. In a particular embodiment, server 1314 comprises a Lightweight Directory Access Protocol Server (LDAP) which contains information regarding the location of worker processes in the system and facilitates communications between worker processes and various components in the system.

Database 1316 is connected to communication bus 1312 and stores data including information regarding users and processes in the system. In a particular embodiment, database 1316 comprises an SQL server database and communicates with various components in the system via the XML communication protocol.

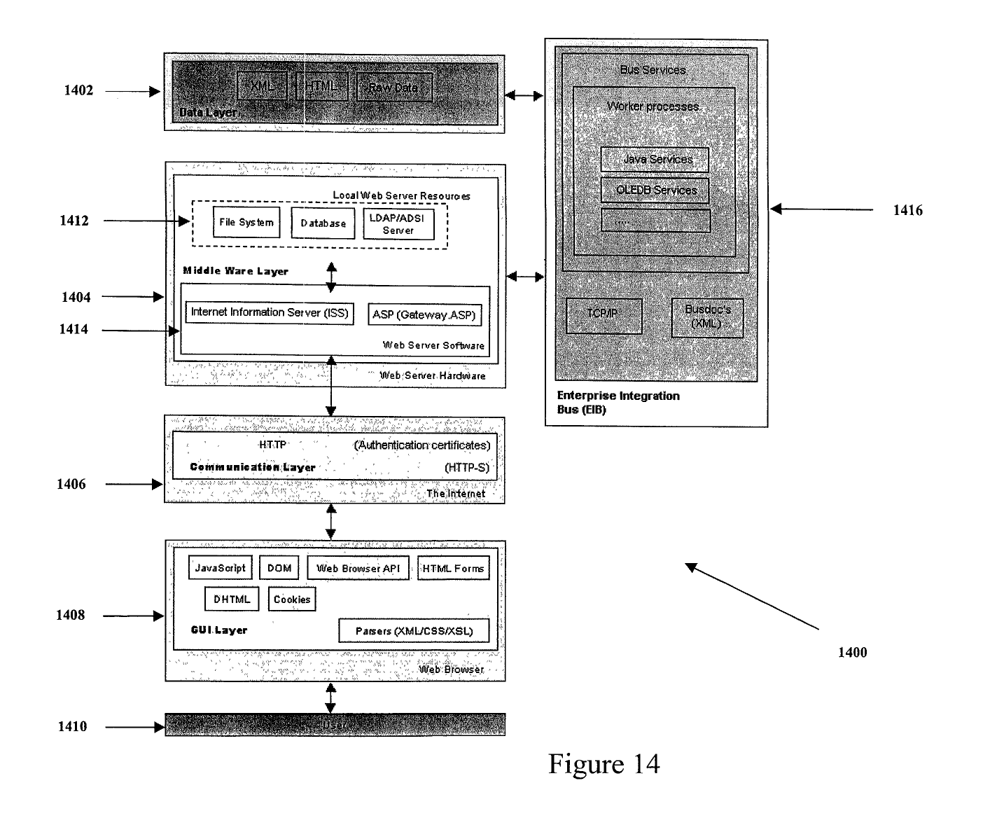

FIG. 14 illustrates various layers of a distributed decision making processing system according to the present invention. The embodiment of FIG. 14 comprises four layers that interact to provide a decision making system with distributed data processing capabilities and enable a user to participate in the group decision making process. Some of these layers communicate with external modules.

System 1400 comprises data layer 1402, middle ware layer 1404, communication layer 1406, graphical user interface layer 1408 and user 1410. Middle ware layer 1404 is disposed between data layer 1402 and communications layer 1406 and facilitates information transmissions between them. Graphical user interface layer 1408 is coupled to middle ware layer 1404 and to user 1410. Communications between user 1410 and data layer 1402 propagate through both communication layer 1406 and middle ware layer 1404. Data layer 1402 and middle ware layer 1404 communicate with enterprise integration bus 1416.

Data layer 1402 comprises data in various formats, including XML, HTML and Iraw data. Data layer 1402 exchanges such data with middle ware layer. Middle ware layer comprises local web server resources 1412. In a particular embodiment, local web server resources 1412 comprise a file system, a database and an LDAP server. Local web server resources 1412 communicate with web server software module 1414 within middle ware layer 1404. In a particular embodiment, web server software module 1414 comprises a gateway and an Internet Information Server.

Communication layer 1406 resides between middle ware layer 1404 and graphical user interface layer 1408. Data transmissions within communication layer 1406 may take place according to various communication protocols, including HTTP, HTTP-S, or authentication certificates. In a particular embodiment, communication layer 1406 comprises a LAN, a WAN, or the Internet.

Graphical user interface layer 1408 comprises various modules for data processing and interaction with users, including JavaScript, DOM. web browser API, HTML forms, DHTML, cookies and parsers (e.g., XML, CSS, or XSL parsers). In a particular embodiment, graphical user interface 1408 comprises a web browser. Graphical user interface layer 1408 provides an interface between user 1410 and system 1400.

In operation, user 1410 interacts with graphical user interface layer 1408 and exchanges data with middle ware layer 1414 via communication layer 1406. In alternative embodiments, middle ware server 1404 processes data entered by user 1410 or transmits data further for remote processing.

In one embodiment of the invention, system 1400 corresponds to client server 1302 from the embodiment of FIG. 13. In that embodiment, respectively, graphical user interface layer 1408 corresponds to browser 1306, communication layer 1406 resides between browser 1306 and gateway 1308, middle ware layer 1404 corresponds to gateway 1308 and data layer 1402 corresponds to anonymous clients 1310. Further, enterprise integration bus 1416 corresponds to communication bus 1312. According to this embodiment, system 1400 performs functions similar to the functions performed by client server 1302 from FIG. 13.

In various embodiments of the present invention, user 1410 may include different types of users, including, for example, project manager, criteria manager, weighting manager, evaluation manager, evaluation assessor, or criteria assessor. In such embodiments, user 1410 may interact with a web browser such as Internet Explorer comprised in graphical user interface 1408 to view and enter information relevant to the user's role in the decision making process. In particular embodiments, the web browser may provide the user with screens similar to the screen examples illustrated in FIGS. 10A-10J. In an embodiment, user 1410 may employ the web browser to send information using the http protocol over the Internet (with the assistance of communication layer 1406) to a decision making data processing module residing in local web server resources 1412, within middle ware layer 1404. To process this information, local web server resources 1412 may interact with other external modules by exchanging XML data using data layer 1402 and middle ware layer 1404.

In an embodiment, for example, user 1410 may comprise a weighting assessor who is evaluating the importance of a set of criteria using pairwise comparison. In this embodiment, the web browser may provide user 1410 with a series of display screens that enable user 1410 to express opinions regarding the importance of specific criteria in the evaluation process. In a particular embodiment, user 1410 may view a screen similar to the screen example shown in FIG. 10D. User 1410 may enter information using the web browser, and this information may be transmitted via communication layer 1406 encoded as html data to the file system comprised in local web server resources 1412.

An advantage of an embodiment of the present invention is that the relative rigorousness of the group decision making process including specific role assignment to various participants may reduce the impact on the final outcome of subjectivity and personal interests of the participants. Additionally, the decision making process provided by an embodiment of the invention may provide an appearance of objectivity to persons whose interests are affected by the outcome of the group decision. For example, shareholders of a corporation may be more likely to endorse a decision made by the management of the corporation if the management employs a group decision-making method according to an embodiment of the invention.

Another advantage of an embodiment of the invention is that participants in the group decision-making process may be more likely to accept the decision and may exhibit increased commitment towards implementation of the decision with a corresponding increase in process quality. For example, in a corporation, if employees of the corporation participate in a group decision making process according to an embodiment of the present invention, the employees may be more willing to implement any changes suggested by the outcome of the decision making process, which may increase the productivity of the employees. Various other embodiments of the invention provide additional advantages in support of decision making for individuals and organizations.

According to various other embodiments of the invention, respective elements of the invention may be embodied by transmitted electronic carrier waves including signals as well as computer readable code and/or commands. Software aspects of the invention may be implemented in a computer readable storage medium such as a computer disk or other storage medium.

The foregoing description of various embodiments of the invention has been presented for purposes of illustration and description. It is not intended to limit the invention to the precise forms described.

What is claimed is:

1. A method comprising:
receiving, in a computer system, a set of alternative choices, the alternative choices provided by a first set of individuals including at least one individual;
receiving, in the computer system, a set of criteria by which the set of alternative choices may be evaluated, the criteria provided by a second set of individuals including at least one individual;
receiving, in the computer system via a data network coupled to the computer system, a set of weights sent to the computer system by a third set of individuals via the computer network, each weight indicating importance of a respective criterion from the set of criteria, the third set of individuals comprising at least one individual;
receiving, in the computer system via the data network, a set of evaluations sent to the computer system by a forth set of individuals, each evaluation corresponding to possible attributes of the respective criteria, the forth set of individuals comprising at least one individual;
requiring membership of individuals in the respective sets of individuals before accepting their respective input; and
based on the set of evaluations and the set of weights, providing a relative analysis of the alternative choices.

2. The method of claim 1 further comprising requiring a security identification that individuals are members of the respective sets of individuals before accepting their respective input.

3. The method of claim 2 wherein the security identification comprises a password.

4. The method of claim 1, wherein the relative analysis of the alternative choices comprises ranking the alternatives based on a score derived from a weighted combination of evaluations, the weighted combination of the evaluations being based on the weights.

5. The method of claim 1, wherein the impact of particular evaluations from the set of evaluations on the relative analysis of the alternative choices depends on the identity of the corresponding individuals in the fourth set of individuals.

6. The method of claim 1, including providing a summary of the input of various individuals.

7. The method of claim 1, wherein the providing a relative analysis of the alternative choices comprises identifying at least one alternative choice from the set of alternative choices based on at least one stop condition.

8. The method of claim 1, including performing a sensitivity analysis.

9. The method of claim 1 further comprising receiving, accessing and using a previously stored evaluation of at least one alternative.

10. The method of claim 1 further comprising receiving, accessing and using a previously stored weight of a criterion.

11. A computer system comprising:
a processing device;
an interface to a data network coupled to the processing device;
logic operable with the processing device that:
receives a set of alternative choices, the alternative choices provided by a first set of individuals including at least one individual;
receives a set of criteria by which the set of alternative choices may be evaluated, the criteria provided by a second set of individuals including at least one individual;
receives via the data network coupled to the computer system, a set of weights sent to the computer system by a third set of individuals via the computer network, each weight indicating importance of a respective criterion from the set of criteria, the third set of individuals comprising at least one individual;
receives via the data network, a set of evaluations sent to the computer system by a forth set of individuals, each evaluation corresponding to possible attributes of the respective criteria, the forth set of individuals comprising at least one individual;
requires membership of individuals in the respective sets of individuals before accepting their respective input; and
based on the set of evaluations and the set of weights, provides a relative analysis of the alternative choices.

12. The system of claim 11, wherein the logic comprises computer software.

13. The system of claim 11, wherein the logic comprises electronic hardware.

14. A method comprising:
receiving, in a computer system, a set of alternative choices;
receiving, in the computer system, a set of criteria by which the set of alternative choices may be evaluated;
receiving, in the computer system via a data network coupled to the computer system, a set of assessments sent to the computer system by a set of individuals via the computer network, each assessment corresponding to a respective criterion from the set of criteria;
assigning different identifications to more than one individual from among the set of individuals; and
based on the assessments and the identifications of the individuals, providing a relative analysis of the alternative choices.

15. The method of claim 14, wherein the assessments comprise weights, each weight indicating importance of a respective criterion from set of criteria.

16. The method of claim 14, wherein the assessments comprise evaluations, each evaluation corresponding to possible attributes of the respective criteria.

17. The method of claim 14, wherein identifiers indicate whether an individual is a specialist, and the method further comprises providing a stronger treatment for the assessment of a specialist in a field corresponding to the respective criterion, based on the identifier of the specialist.

18. The method of claim 17, wherein at least a possible identifier is an identifier of a financial specialist and the method further comprises providing a stronger treatment of the assessment of a financial criterion, depending on the identifier of the specialist being the identifier of a financial specialist.

19. The method of claim 17, wherein at least a possible identifier is an identifier of a technical specialist and the method further comprises providing a stronger treatment of the assessment of a technical criterion, depending on the identifier of the specialist being the identifier of a technical specialist.

20. A computer system comprising:
a processing device;
an interface to a data network coupled to the processing device;
logic operable with the processing device that:
receives a set of alternative choices;
receives a set of criteria by which the set of alternative choices may be evaluated;
receives via a data network coupled to the computer system, a set of assessments sent to the computer system by a set of individuals via the computer network, each assessment corresponding to a respective criterion from the set of criteria;
assigns different identifications to more than one individual from among the set of individuals; and
based on the assessments and the identifications of the individuals, provides a relative analysis of the alternative choices.

21. A method comprising:
receiving, in a computer system, a set of alternative choices;
receiving, in the computer system, a set of criteria by which the set of alternative choices may be evaluated;
receiving, in the computer system via a data network coupled to the computer system, a set of assessments sent to the computer system by a set of individuals including at least one individual, via the computer network, the assessments comprising a set of weights and a set of evaluations, the assessments corresponding to respective criteria from the set of criteria, the assessments including pairwise comparison;
based on the identity of the individuals from the set of individuals, providing a solution that avoids iterative computations; and
based on the solution, providing a relative analysis of the alternative choices.
